(19) United States
(12) Patent Application Publication
(10) Pub. No.: US 2025/0340677 A1
(43) Pub. Date: Nov. 6, 2025

(54) FUNCTIONALIZATION OF SOLUBLE POLYDIENES AND POLYISOPRENES USING DITHIOPHOSPHORIC ACIDS

(71) Applicant: ARIZONA BOARD OF REGENTS ON BEHALF OF THE UNIVERSITY OF ARIZONA, Tucson, AZ (US)

(72) Inventors: Dong Chul Pyun, Tucson, AZ (US); Jon Njardarson, Tucson, AZ (US); Jianhua Bao, Tucson, AZ (US)

(73) Assignee: ARIZONA BOARD OF REGENTS ON BEHALF OF THE UNIVERSITY OF ARIZONA, Tucson, AZ (US)

(21) Appl. No.: 19/264,329

(22) Filed: Jul. 9, 2025

Related U.S. Application Data
(63) Continuation of application No. PCT/US2024/011003, filed on Jan. 10, 2024.
(60) Provisional application No. 63/438,370, filed on Jan. 11, 2023.

(51) Int. Cl. C08C 19/24; C08C 19/20; C08F 8/34; C08F 8/40; C08F 132/08; C08F 136/06; C08F 136/08

(52) U.S. Cl. CPC C08C 19/24; C08C 19/20; C08F 8/34; C08F 8/40; C08F 132/08; C08F 136/06; C08F 136/08

(57) ABSTRACT

A composition including a reaction product of a polymer including one or more olefins and a dithiophosphoric acid compound.

### CROSS REFERENCE TO RELATED APPLICATIONS

This application is a continuation of International Application No. PCT/US2024/011003 filed Jan. 10, 2024, which claims the benefit of priority to U.S. Provisional Patent Application No. 63/438,370 filed Jan. 11, 2023, each of which are incorporated by reference in their entireties for any and all purposes.

### GOVERNMENT SUPPORT

This invention was made with government support under Grant No. 2118578 awarded by the National Science Foundation. The government has certain rights in the invention.

### FIELD

The present invention relates to the post-polymerization functionalization of olefin-containing polymers with dithiophosphoric acids.

### BACKGROUND

Dithiophosphoric acids (DTPAs) can be readily made by the reaction of phosphorus pentasulfide (P₂S₅), or the dimeric form (P₄S₁₀) with alcohols (ROH) to form mono-functional dithiophosphoric acids, bi-functional dithiophosphoric acids, or multi-functional dithiophosphoric acids. While dithiophosphoric acids have long been known in organic synthesis, the application and utility of these molecules for polymer functionalization have not been developed.

This disclosure discloses the post-polymerization functionalization of synthetic, or naturally occurring olefin-containing polymers with DTPAs. Specifically, the mono-functional and bi-functional dithiophosphoric acids (DTPAs) disclosed herein are able to undergo efficient chemical reactions with a wide range of olefinic polymers in bulk-neat conditions or in solution via electrophilic addition processes. The resulting post-polymerization functionalized polymers provide a wide range of new functional soluble polymers. Such functionalized soluble polymers provide a broad technological impact as both a new inexpensive chemical process for polymer synthesis for the petrochemical and polymer industries and as a route to low cost, specialty optical and flame retardant polymers.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

This disclosure demonstrates that mono-functional and bi-functional dithiophosphoric acids (DTPAs) are able to undergo efficient chemical reactions with a wide range of olefinic polymers in bulk-neat conditions or in solution via electrophilic addition processes, providing newly functionalized polymers that offer a new class of versatile chemistry and substrates to create new polymers. These mono-functional and bi-functional DTPAs react with the olefinic polymers under mild reaction conditions with near quantitative yields. Suitable olefins include polybutadienes, polyisoprenes, naturally occurring soluble rubber resins from guayule feedstocks, natural or gum rubber from Hevea Brasiliensis, Landophia Owariensis, and other sources, such as dandelions. Also, more rigid polydienes derived from the ring-opening metathesis polymerization (ROMP) of norbornene or other cyclic olefins may also react with the mono-functional DTPAs described herein. Additionally, the DTPAs disclosed herein are shown to add across the olefin-containing polymer in a Markovnikov manner. The reaction products described herein represent a new class of polymers suitable for petrochemical and/or biorenewable and polymer industries and/or low cost, specialty optical and flame retardant polymers.
Provided in one aspect is a composition comprising a reaction product of a polymer comprising one or more olefins and a dithiophosphoric acid compound of Formula (I) or Formula (II):

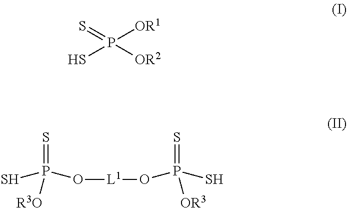

wherein:
R¹ and R² are each individually alkyl, heteroalkyl, cycloalkyl, heterocyclyl, aryl, heteroaryl, or aralkyl; or
R¹ and R² are joined together with the oxygen atoms to which they are attached and any intervening atoms to form a ring,
each R³ is individually alkyl, heteroalkyl, cycloalkyl, heterocyclyl, aryl, heteroaryl, or aralkyl; and
L¹ is alkylene.

In some embodiments, the compound is of Formula (I). In some embodiments, R¹ and R² are each individually alkyl. In some embodiments, R¹ and R² are each individually methyl, ethyl, or isopropyl. In some embodiments, R¹ and R² are joined together with the oxygen atoms to which they are attached and any intervening atoms to form a ring. In some embodiments, R¹ and R² are joined together with the oxygen atoms to which they are attached and any intervening atoms to form a six membered ring.

In some embodiments, the dithiophosphoric acid compound is any one of the following:

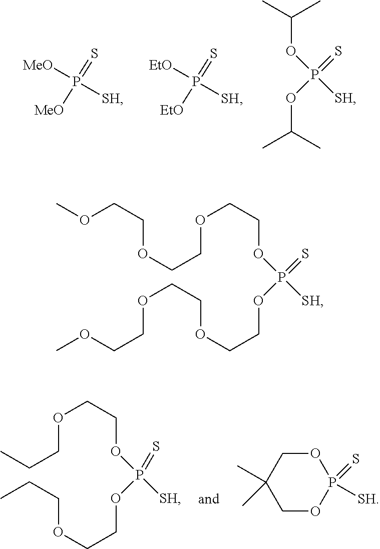

In some embodiments, the compound is of Formula (II). In some embodiments, each R³ are individually alkyl. In some embodiments, each R³ are individually methyl, ethyl, or isopropyl. In some embodiments, L¹ is C₄ to C₂₀ alkylene. In some embodiments, L¹ is C₆ alkylene, C₁₀ alkylene or C₁₂ alkylene.

In some embodiments, the dithiophosphoric acid compound is any one of the following:

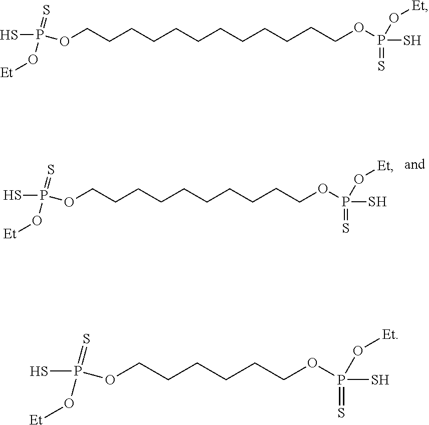 [SMILES: CCOP(=S)(S)OCCCCCCCCCCCCOP(=S)(S)OCC ; CCOP(=S)(S)OCCCCCCCCCCOP(=S)(S)OCC ; CCOP(=S)(S)OCCCCCCOP(=S)(S)OCC]

In some embodiments, the polymer comprising one or more olefins is a reaction product of a ring-opening metathesis polymerization of a cycloalkene or norbornene. In some embodiments, the cycloalkene is a strained olefin.

In some embodiments, the polymer comprising one or more olefins is polynorbornene. In some embodiments, the polynorbornene comprises a dithiophosphoric acid moiety and has the following formula of:

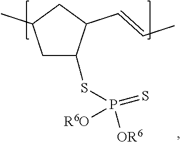

wherein each R⁶ is independently alkyl, heteroalkyl, cycloalkyl, heterocyclyl, aryl, heteroaryl, or aralkyl.

In some embodiments, the polymer comprising one or more olefins is polybutadiene or polyisoprene. In some embodiments, the polyisoprene is cis-1,4-polyisoprene.

In some embodiments, the reaction product is of the formula:

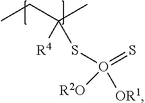

wherein R⁴ is alkyl, heteroalkyl, cycloalkyl, heterocyclyl, aryl, heteroaryl, or aralkyl, or

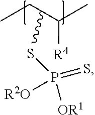

wherein R⁴ is hydrogen.

In some embodiments, the reaction product is of the formula:

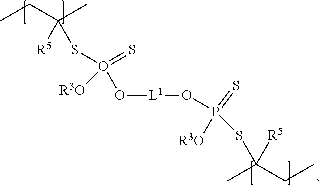

wherein each R⁵ is independently alkyl, heteroalkyl, cycloalkyl, heterocyclyl, aryl, heteroaryl, or aralkyl, or

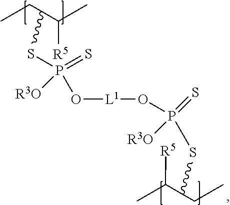

wherein each R⁵ is independently hydrogen.

Provided in another aspect is article of manufacture comprising any one of the reaction products described herein.

Provided in another aspect is a fire retardant composition comprising any one of the reaction products described herein.

Provided in another aspect is an optical polymer composition comprising any one of the reaction products described herein.

Provided in another aspect is a method for making a reaction product of a polymer comprising one or more olefins and a dithiophosphoric acid compound of Formula (I) or Formula (II):

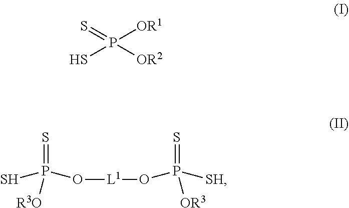

the method comprising:
contacting the polymer comprising one or more olefins with the dithiophosphoric acid;
wherein:
   R¹ and R² are each individually alkyl, heteroalkyl, cycloalkyl, heterocyclyl, aryl, heteroaryl, or aralkyl; or
   R¹ and R² are joined together with the oxygen atoms to which they are attached and any intervening atoms to form a ring;
   each R³ are individually alkyl, heteroalkyl, cycloalkyl, heterocyclyl, aryl, heteroaryl, or aralkyl; and
   L¹ is alkylene.

In some embodiments, contacting the polymer comprising one or more olefins with the dithiophosphoric acid does not require a solvent. In some embodiments, the dithiophosphoric acid is used as the solvent or solubilizer.

In some embodiments, contacting the polymer comprising one or more olefins with the dithiophosphoric acid requires heating of at least about 80° C. In some embodiments, contacting the polymer comprising one or more olefins with the dithiophosphoric acid requires heating of about 100° C.

### BRIEF DESCRIPTION OF THE DRAWINGS

FIG. 1 is an illustration of a DCS (exotherm) of C₁₀-bis-DTPA crosslinked PIs with varying loadings of the C₁₀-bis-DTPA crosslinker.

FIG. 2 is an illustration of UTM tensile stress-strain plots of crosslinked PIs with varying loadings of the C10-bis-DTPA crosslinker.

FIG. 3 is a schematic diagram of the UL-94 vertical flame retardancy test employed in the Examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be constructed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

“Alkylene” refers to a straight or branched divalent hydrocarbon chain linking the rest of the molecule to a radical group, consisting solely of carbon and hydrogen, containing no unsaturation and having from one to twelve carbon atoms, for example, methylene, ethylene, propylene, n-butylene, and the like. The alkylene chain is attached to the rest of the molecule through a single bond and to the radical group through a single bond. The points of attachment of the alkylene chain to the rest of the molecule and to the radical group can be through one carbon in the alkylene chain or through any two carbons within the chain. In other embodiments, an alkylene comprises four to twenty carbon atoms (e.g., C₄-C₂₀ alkylene).

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl” or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heteroalkyl group include straight and branched chain alkyl groups as defined above and further include 1, 2, 3, 4, 5, or 6 heteroatoms independently selected from oxygen, sulfur, and nitrogen. Thus, heteroalkyl groups include 1 to 12 carbon atoms, 1 to 10 carbons or, in some embodiments, from 1 to 8, or 1, 2, 3, 4, 5, or 6 carbon atoms, or any range therein (e.g., 1-4). Examples of heteroalkyl groups include, but are not limited to, —(CH₂CH₂O)₁₋₅CH₃, —(CH₂)₁₋₆O(CH₂)₁₋₆ CH₃, —(CH₂)₁₋₆NR^{a}(CH₂)₁₋₆ CH₃, —(CH₂)₁₋₆S(CH₂)₁₋₆ CH₃, —(CH₂)₁₋₆O(CH₂)₁₋₆O(CH₂)₁₋₆ CH₃, —(CH₂)₁₋₆ NR^{a}(CH₂)₁₋₆ NR^{a}(CH₂)₁₋₆CH₃, —(CH₂)₁₋₆O(CH₂)₁₋₆O(CH₂)₁₋₆O(CH₂)₁₋₆CH₃, —(CH₂)₁₋₆NR^{a}(CH₂)₁₋₆NR^{a}(CH₂)₁₋₆NR^{a}(CH₂)₁₋₆CH₃, with the total number of carbon atoms in the heteroalkyl group being 1 to 12 and Ra is a hydrogen or a substituted or unsubstituted alkyl, alkenyl, aryl or aralkyl group. Other examples of heteroalkyl groups include, but are not limited to, groups having different heteroatoms in a single group. Such examples of heteroalkyl groups include, but are not limited to, —(CH₂)₁₋₆S(CH₂)₁₋₆O(CH₂)₁₋₆, —(CH₂)₁₋₆ NR^{a}(CH₂)₁₋₆)O(CH₂)₁₋₆, —(CH₂)₁₋₆O(CH₂)₁₋₆ NR^{a}(CH₂)₁₋₆S(CH₂)₁₋₆, —(CH₂)₁₋₆NR^{a}(CH₂)₁₋₆O(CH₂)₁₋₆S(CH₂)₁₋₆, with the total number of carbon atoms in the heteroalkyl group being 1 to 12. In some embodiments, heteroalkyl groups include, but are not limited to, polyoxyethylene groups, such as —(OCH₂CH₂—)₁₋₅CH₃, for example, —O(CH₂)₂O(CH₂)₂OCH₃, —O(CH₂)₂O(CH₂)₂O(CH₂)₂OCH₃, —O(CH₂)₂O(CH₂)₂O(C H₂)₂O(CH₂)₂OCH₃.

Aralkyl groups are substituted aryl groups in which an alkyl group as defined above has a hydrogen or carbon bond of the alkyl group replaced with a bond to an aryl group as defined above. In some embodiments, aralkyl groups contain 7 to 14 carbon atoms, 7 to 10 carbon atoms, e.g., 7, 8, 9, or 10 carbon atoms or any range therein (e.g., 7-8). Aralkyl groups may be substituted or unsubstituted. Substituted aralkyl groups may be substituted at the alkyl, the aryl or both the alkyl and aryl portions of the group. Representative substituted and unsubstituted alkaryl groups include but are not limited to alkylphenyl such as methylphenyl, (chloromethyl)phenyl, chloro(chloromethyl)phenyl, or fused alkaryl groups such as 5-ethylnaphthalenyl.

Heterocyclyl groups are non-aromatic ring compounds containing 3 or more ring members, of which one or more is a heteroatom such as, but not limited to, N, O, and S. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass partially unsaturated and saturated ring systems, such as, for example, imidazolinyl and imidazolidinyl groups. The phrase also includes bridged polycyclic ring systems containing a heteroatom such as, but not limited to, quinuclidyl. The phrase also includes heterocyclyl groups that have other groups, such as alkyl, oxo or halo groups, bonded to one of the ring members, referred to as “substituted heterocyclyl groups”. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, pyrrolinyl, piperidyl, piperazinyl, morpholinyl, thiomorpholinyl, tetrahydropyranyl, and tetrahydrothiopyranyl groups. Representative substituted heterocyclyl groups may be mono-substituted or substituted more than once, such as, but not limited to, morpholinyl groups, which are 2-, 3-, 4-, 5-, or 6-substituted, or disubstituted with various substituents such as those listed above. The heteroatom(s) may also be in oxidized form, if chemically possible.

Heteroaryl groups are aromatic ring compounds containing 5 or more ring members, of which, one or more is a heteroatom such as, but not limited to, N, O, and S. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, imidazolyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. The phrase “heteroaryl groups” includes fused ring compounds and also includes heteroaryl groups that have other groups bonded to one of the ring members, such as alkyl groups, referred to as “substituted heteroaryl groups.” Representative substituted heteroaryl groups may be substituted one or more times with various substituents such as those listed above. The heteroatom(s) may also be in oxidized form, if chemically possible.

In general, the terms “alkyl,” “heteroalkyl,” “cycloalkyl,” “heterocyclyl,” “aryl,” “heteroaryl,” and “aralkyl” may be further substituted by one or more groups unless indicated otherwise. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, the terms “those defined above” and “those defined herein” when referring to a variable incorporates by reference the broad definition of the variable as well as any narrow and/or preferred definitions, if any.

Described herein are post-polymerization functionalized polymers that are obtained from the reaction of an olefin-containing polymer (e.g., polybutadienes, polyisoprenes, and polymers obtained from ring-opening metathesis polymerization (ROMP)) with dithiophosphoric acids (DTPAs). The DTPA compounds described herein may have any one of the below applications:
1. Mono-DTPAs used for post-polymerization modification of polyenes
2. Di-, multi-DTPAs for step-growth polymerization with di-, or multiene unsaturated monomers to form high molar mass polymers; and
3. Mono-DTPA norbornenes for uses in ROMP and post-polymerization functionalization by other mono-DTPAs.

As demonstrated in the Examples, the reaction of an olefin-containing polymer with DTPAs proceed under mild conditions and in near quantitative yields. Specifically the Examples show the synthesis and application of DTPAs for the functionalization of challenging polyenes, namely polyisoprene (PI) and polynorbornene (pNB) prepared by ring-opening metathesis polymerization (ROMP). The high heteroatom content within DTPA moieties impart intriguing bulk properties to poly-ene materials after direct electrophilic addition reactions to the polymer backbone introducing DTPAs as side chain groups that enhances both the optical and flame retardant properties of these materials. Also the ability to prepare crosslinked polydiene films with di-functional DTPAs, where the crosslinking density and thermomechanical properties can be directly tuned by DTPA feed ratios, is demonstrated. In some embodiments, no solvent is required in the reaction since the DTPA serves as both the reagent and solvent/solubilizer. Also, these reactions proceed in a Markovnikov manner.

Addition of sulfur functional groups across double bonds in polymers to create new polymer products with C—S bonds has historically focused on treatment with elemental (sulfur, S₈) to achieve additions across double bonds and cross-linking (vulcanization) to provide the desired material properties. Focused sulfur-group additions across un-activated polymer double bonds as those found in polybutadiene, polyisoprene, and ring-opening-metathesis polymerization (ROMP) products, wherein all double bonds are fully consumed resulting in a targeted functional group being added without any cross-linking are rare and have primarily been done using thiol-ene radical based chemistry. In thiol-ene radical additions across unactivated double bonds like in polyisoprene the sulfur radical adds to the less substituted (less sterically congested) double bond to form the anti-Markovnikov addition product, wherein the new C—S bond is at the less substituted carbon and the new C—H bond as the more substituted carbon atom of the original double bond.

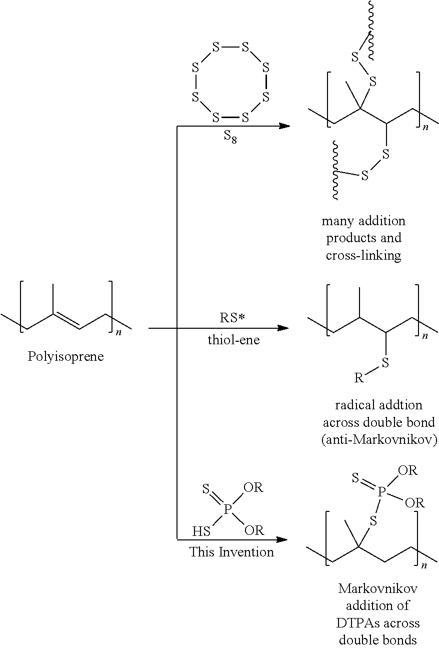

In this disclosure, diethyl dithiophosphoric acid, HSP═S(OEt)₂, and other DTPA's (HSP═S(OR)₂) are shown to add quantitatively across all the double bonds of polybutadiene, polyisoprene, and ROMP-polymer products. These new reactions take place in the absence of solvent, with DTPA serving the role of reagent and solubilizer (solvent), and with gentle heating enable additions of DTPA's across all double bonds selectively in a Markovnikov fashion as evident from nuclear magnetic resonance (NMR) analysis. This simple new efficient and scalable olefin-polymer addition reaction requires simple washing to remove excess unreacted DTPAs followed by precipitation to afford new polymer products.

Exemplary embodiments of the reaction of olefin-containing polymers with DTPAs based on the Examples are shown below. As demonstrated in the Examples, this disclosure shows that polybutadienes of different molecular weights may be treated with diethyl dithiophosphoric acids to install a dithiophosphate at the olefinic carbons on the polymers in a quantitative manner. Importantly, this same addition has been shown to be successful for polyisoprene and to add selectively in a Markovnikov fashion to add dithiophosphate group at the more hindered carbon. A sample of guayule has been similarly subjected to three different dithiophosphoric acids (diethyl, dimethyl and di-isopropyl) all of which added across all of guayules double bonds. Polynorbornene has also been shown to be compatible for this post-polymerization functionalization approach as has a designer polynorbornene with an embedded dithiophosphate group.

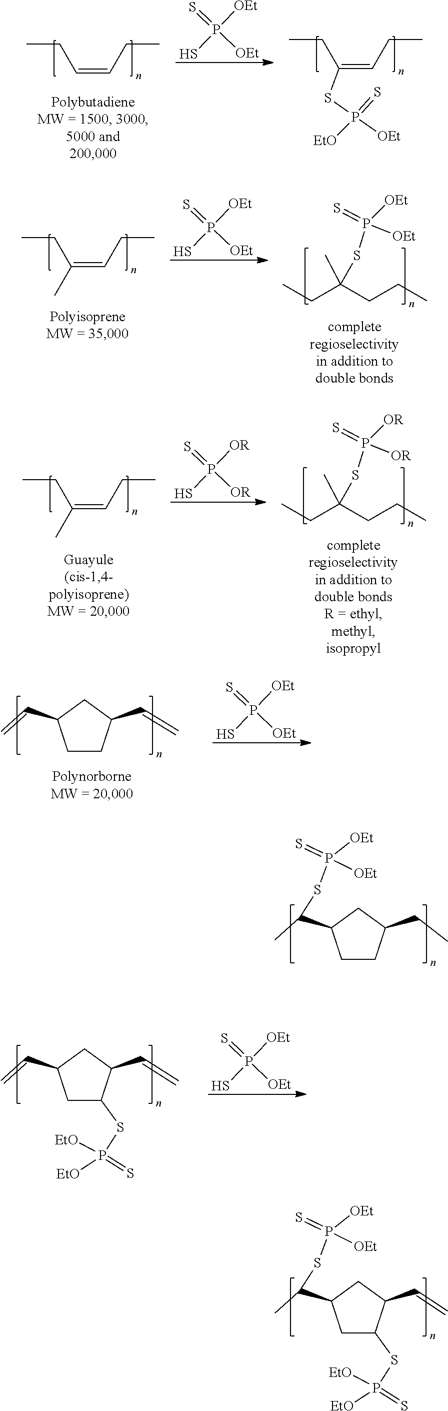

Also, the Examples also demonstrate the preparation of bi-functional DTPAs, where such compounds are prepared by reacting at least two equivalents of a dithiophosphoric acid with a diol (such as an aliphatic diol having varying lengths, e.g., C10, C12, and C20). These bi-functional DTPAs (or bis-DTPAs) may be further reacted with an olefin-containing polymer, such as polyisoprene). An exemplary embodiment is illustrated below.

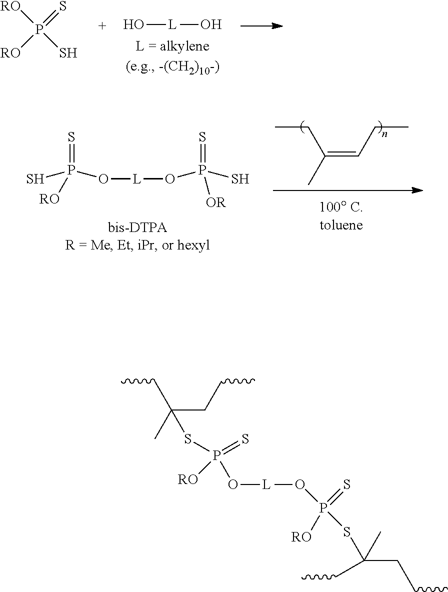

Provided in one aspect is a composition that includes a reaction product of a polymer that includes one or more olefins and a dithiophosphoric acid compound of Formula (I) or Formula (II):

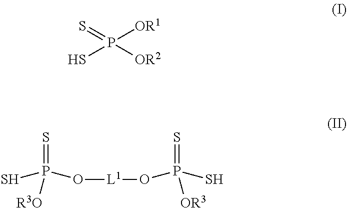

wherein:
   R¹ and R² are each individually alkyl, heteroalkyl, cycloalkyl, heterocyclyl, aryl, heteroaryl, or aralkyl; or
   R¹ and R² are joined together with the oxygen atoms to which they are attached and any intervening atoms to form a ring,
   each R³ are individually alkyl, heteroalkyl, cycloalkyl, heterocyclyl, aryl, heteroaryl, or aralkyl; and
   L¹ is alkylene.

Provided in another aspect is a composition that includes a reaction product of a polymer including one or more olefins and a dithiophosphoric acid compound of Formula (I):

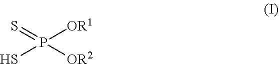

wherein:
   R¹ and R² are each individually alkyl, heteroalkyl, cycloalkyl, heterocyclyl, aryl, heteroaryl, or aralkyl; or
   R¹ and R² are joined together with the oxygen atoms to which they are attached and any intervening atoms to form a ring.

In some embodiments, the compound may be of Formula (I). In some embodiments, R¹ and R² may be each individually alkyl, such as C₁-C₁₀ alkyl, C₁-C₈ alkyl, C₁-C₆ alkyl, and C₁-C₄ alkyl. In some embodiments, R¹ and R² are each individually methyl, ethyl, or isopropyl.

In some embodiments, R¹ and R² are joined together with the oxygen atoms to which they are attached and any intervening atoms to form a ring (which may be substituted or unsubstituted). In some embodiments, R¹ and R² are joined together with the oxygen atoms to which they are attached and any intervening atoms to form a five-, six-, seven-, or eight-membered ring. In some embodiments, R¹ and R² are joined together with the oxygen atoms to which they are attached and any intervening atoms to form a six-membered ring.

In some embodiments, the dithiophosphoric acid compound may be any one of the following:

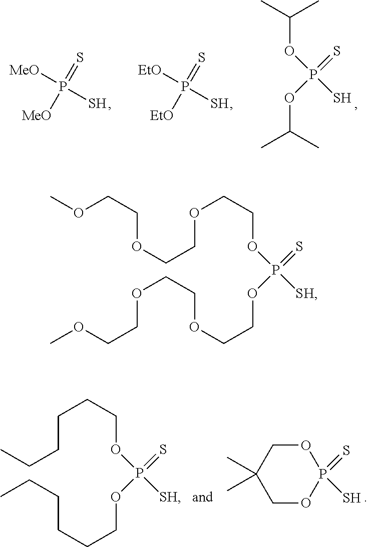

In some embodiments, the compound may be of Formula (II). In some embodiments, each R³ may be individually alkyl, such as C₁-C₁₀ alkyl, C₁-C₈ alkyl, C₁-C₆ alkyl, and C₁-C₄ alkyl. In some embodiments, each R³ may be individually methyl, ethyl, or isopropyl.

In some embodiments, L¹ is C₄ to C₂₀ alkylene, such as C₄ alkylene, C₅ alkylene, C₆ alkylene, C₇ alkylene, C₈ alkylene, C₉ alkylene, C₁₀ alkylene, C₁₁ alkylene, C₁₂ alkylene, C₁₃ alkylene, C₁₄ alkylene, C₁₅ alkylene, C₁₋₆ alkylene, C₁₇ alkylene, C₁₈ alkylene, C₁₉ alkylene, and C₂₀ alkylene. In some embodiments, L¹ is C₆ alkylene, C₁₀ alkylene or C₁₂ alkylene. In some embodiments, L¹ is C₁₀ alkylene.

In some embodiments, the dithiophosphoric acid compound may be any one of the following:

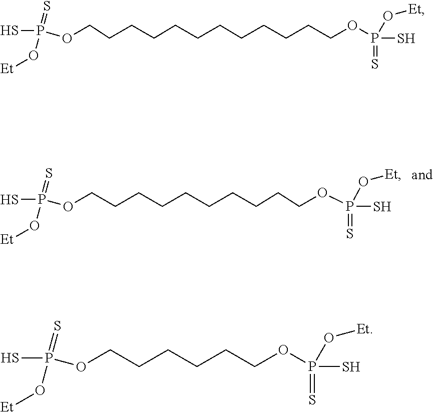 [SMILES: CCOP(=S)(S)OCCCCCCCCCCCCOP(=S)(S)OCC ; CCOP(=S)(S)OCCCCCCCCCCOP(=S)(S)OCC ; "and" ; CCOP(=S)(S)OCCCCCCOP(=S)(S)OCC]

Suitable one or more olefin-containing polymers that may react with the DTPAs that are described herein include a polymer/reaction product of a ring-opening metathesis polymerization. These olefin-containing polymers may have a molecular weight of from about 500 to about 500,000 g/mol, including about 1500, 3000, 5000, 20,000, 35,000, and 200,000 g/mol. Suitable reaction products obtained from ring-opening polymerization include, but are not limited, those from a ring-opening metathesis polymerization of a strained olefin, including cycloalkene or norbornene. In some embodiments, the cycloalkene is a strained olefin. In some embodiments, the polymer comprising one or more olefins is polynorbornene.

Illustrative olefins for use in ring-opening polymerization include, but are not limited to, cyclopropene, cyclobutene, cyclopentene, cyclohexene, cycloheptene, cyclooctene, cyclononene, cyclodecene, cycloundecene, cyclododecene and the like. Other examples include bicyclic olefins, such as bicyclo[2.2.1]heptene, norbornene, norbornadiene, cyclo[3.3.0]octene, octahydropentelene, decahydronaphthelene, bicyclo[2.2.2]octene, and the like, as well as derivatives thereof.

Suitable one or more olefin-containing polymers that may react with the DTPAs that are described herein include polybutadienes or polyisoprenes. These olefin-containing polymers may have a molecular weight of from about 500 to about 500,000, including about 1500, 3000, 5000, 20,000, 35,000, and 200,000. In some embodiments, the polymer including one or more olefins is polybutadiene or polyisoprene. In some embodiments, the polyisoprene is cis-1,4-polyisoprene (Guayule).

In some embodiments, the one or more olefin-containing polymers may include a polynorbornene comprises a dithiophosphoric acid moiety and has the following formula of:

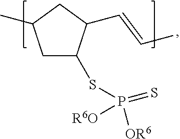

wherein each R⁶ is independently alkyl, heteroalkyl, cycloalkyl, heterocyclyl, aryl, heteroaryl, or aralkyl.

In some embodiments, each R⁶ is independently alkyl, such as C₁-C₁₀ alkyl, C₁-C₈ alkyl, C₁-C₆ alkyl, and C₁-C₄ alkyl. In some embodiments, each R⁶ is individually methyl, ethyl, or isopropyl.

In some embodiments, the reaction product is of the formula:

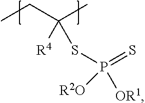

wherein R⁴ is hydrogen, alkyl, heteroalkyl, cycloalkyl, heterocyclyl, aryl, heteroaryl, or aralkyl, or

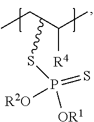

wherein R⁴ is hydrogen.

In some embodiments, R⁴ is alkyl, heteroalkyl, cycloalkyl, heterocyclyl, aryl, heteroaryl, or aralkyl (e.g., a Markovnikov product). In some embodiments, R⁴ is alkyl, such as C₁-C₁₀ alkyl, C₁-C₈ alkyl, C₁-C₆ alkyl, and C₁-C₄ alkyl.

In some embodiments, the reaction product is of the formula:

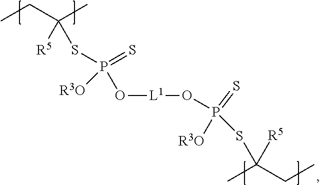

wherein each R⁵ is independently alkyl, heteroalkyl, cycloalkyl, heterocyclyl, aryl, heteroaryl, or aralkyl, or

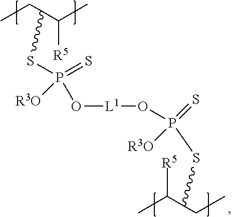

wherein each R⁵ is independently hydrogen.

In some embodiments, each R⁵ is independently alkyl, heteroalkyl, cycloalkyl, heterocyclyl, aryl, heteroaryl, or aralkyl (e.g., a Markovnikov product). In some embodiments, each R⁵ is alkyl, such as C₁-C₁₀ alkyl, C₁-C₈ alkyl, C₁-C₆ alkyl, and C₁-C₄ alkyl.

Provided in another aspect is a method for making a reaction product of a polymer comprising one or more olefins and a dithiophosphoric acid compound of Formula (I) or Formula (II):

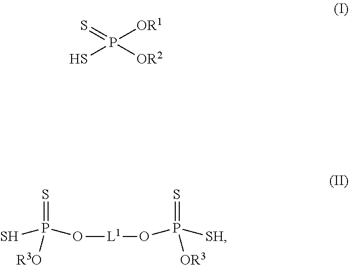

the method comprising:
contacting the polymer comprising one or more olefins with the dithiophosphoric acid;
wherein:
   R¹ and R² are each individually alkyl, heteroalkyl, cycloalkyl, heterocyclyl, aryl, heteroaryl, aralkyl, heterocyclylalkyl, cycloalkylalkyl, or heteroarylalkyl; or
   R¹ and R² are joined together with the oxygen atoms to which they are attached and any intervening atoms to form a ring,
   each R³ are individually alkyl, heteroalkyl, cycloalkyl, heterocyclyl, aryl, heteroaryl, or aralkyl; and
   L¹ is alkylene.

Provided in another aspect is a method for making a reaction product of a polymer including one or more olefins and a dithiophosphoric acid compound, the method including: contacting the polymer comprising one or more olefins with the dithiophosphoric acid; wherein the dithiophosphoric acid compound is of Formula (I):

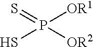

wherein:
   R¹ and R² are each individually alkyl, heteroalkyl, cycloalkyl, heterocyclyl, aryl, heteroaryl, aralkyl, heterocyclylalkyl, cycloalkylalkyl, or heteroarylalkyl; or
   R¹ and R² are joined together with the oxygen atoms to which they are attached and any intervening atoms to form a ring.

In some embodiments, contacting the polymer including one or more olefins with the dithiophosphoric acid does not require a solvent. In some embodiments, the dithiophosphoric acid is used as the solvent or solubilizer.

In some embodiments, contacting the polymer including one or more olefins with the dithiophosphoric acid requires heating of at least about 50° C., including at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., and at least about 150° C.

In some embodiments, contacting the polymer comprising one or more olefins with the dithiophosphoric acid requires heating of about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., and about 150° C. In some embodiments, contacting the polymer comprising one or more olefins with the dithiophosphoric acid requires heating of about 100° C.

In some embodiments, the dithiophosphoric acid reacts with the polymer comprising one or more olefins in a Markovnikov manner.

### Polymer Applications:

The fields of use envisioned from this polymer functionalization of synthetic polydienes are far reaching but can be applied to the following targets:
1) Vulcanization of natural rubber, soluble polydienes, synthetic SBR, polynorbornene, polynorbornene derivatives and other polymers derived from ring-opening metathesis, or any polymer containing an unsaturation.
2) Synthesis of new functional polymer from these same synthetic polydienes to tune the hydrophobicity/hydrophilicity of these polydienes.
3) Optical polymers where the introduction of DTPA side chain groups can raise the refractive index of the synthetic polydiene precursor material.
4) Flame retardant polymers where the introduction of DTPA side chain groups impart flame retardancy to the synthetic polydiene precursor material.

Also provided in another aspect is an article of manufacture comprising any one of the reaction products (e.g., post-polymerization functionalized polymers) described herein. The post-polymerization functionalized polymers described herein may be useful as fire retardant polymers or compositions thereof and/or as optical polymers or compositions thereof.

The present invention, thus generally described, will be understood more readily by reference to the following examples, which are provided by way of illustration and are not intended to be limiting of the present invention.

### EXAMPLES

The following examples illustrate various protocols for preparing compounds and devices according to the embodiments described above. The examples should in no way be construed as limiting the scope of the present technology.

While certain embodiments have been illustrated and described, it should be understood that changes and modifications can be made therein in accordance with ordinary skill in the art without departing from the technology in its broader aspects as defined in the following claims.

### Example 1—Experimental Procedures

### Synthesis of dimethyl dithiophosphoric Acid

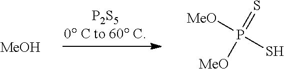

A 25 ml round bottom flask equipped with a stir bar and reflux condenser was charged with methanol (2.24 g, 70 mmol), followed by the portionwise addition of phosphorus pentasulfide (4.44 g, 20 mmol) at 0° C. The reaction was heated at 60° C. for 3 hours and liberated gasses were trapped with a bleach solution. After cooling to room temperature, the remaining solid was filtered to yield the product as a colorless oil (2.64 g, 48%).

### Synthesis of Diisopropyl Dithiophosphoric Acid

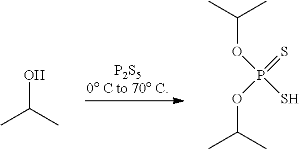

A 25 ml round bottom flask equipped with a stir bar and reflux condenser was charged with 2-propanol (4.2 g, 70 mmol), followed by the portionwise addition of phosphorus pentasulfide (4.44 g, 20 mmol) at 0° C. The reaction was heated at 70° C. for 3 hours and the liberated gasses were trapped with a bleach solution. After cooling to room temperature, the remaining solid was filtered to yield the product as a colorless oil (5.78 g, 77%).

### Synthesis of O,O′-bis[2-(2-methoxyethoxyethoxy)ethyl]hydrogen dithiophosphate

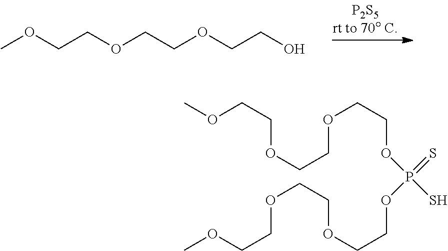 [SMILES: COCCOCCOCCO ; COCCOCCOCCOP(=S)(S)OCCOCCOCCOC]

A 25 ml round bottom flask equipped with a stir bar and reflux condenser was charged with triethyleneglycol monomethyl ether (11.5 g, 70 mmol), followed by the portionwise addition of phosphorus pentasulfide (4.44 g, 20 mmol) at room temperature. The reaction was heated at 70° C. for 3 hours and the liberated gasses were trapped with a bleach solution. After cooling to room temperature, the remaining solid was filtered to yield the product as a pale yellow oil (13.5 g, 91%).

### Synthesis of O,O′-dihexyl dithiophosphate

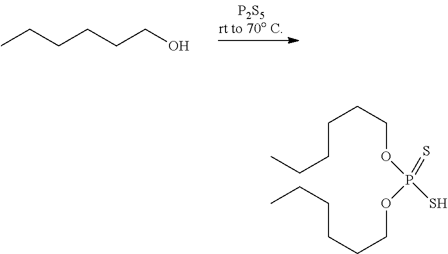

A 25 ml round bottom flask equipped with a stir bar and reflux condenser was charged with 1-hexanol (7.15 g, 70 mmol), followed by the portionwise addition of phosphorus pentasulfide (4.44 g, 20 mmol) at room temperature. The reaction was heated at 70° C. for 3 hours and the liberated gasses were trapped with a bleach solution. After cooling to room temperature, the remaining solid was filtered to yield the product as a colorless oil (7.12 g, 68%).

### Synthesis of 5,5-Dimethyl-2-sulfanyl-2-thioxo-1,3,2-dioxaphosphorinane

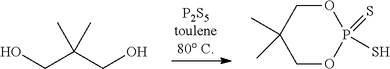

To a suspension of phosphorus pentasulfide (4.44 g, 20 mmol) in 25 ml dry toluene was added 2,2-dimethyl-1,3-propanediol (4.16 g, 40 mmol) portionwise under an inert atmosphere. After stirring at 80° C. overnight with a bleach trap for the liberating gasses, unreacted solid was removed by filtration, and the filtrate was concentrated under vacuum. The residue was dissolved in 25 ml hot CCl₄ and then placed in a −15° C. freezer overnight. The product was collected by filtration as a white solid (3.9 g, 49%).

### Synthesis of DTPA-PB

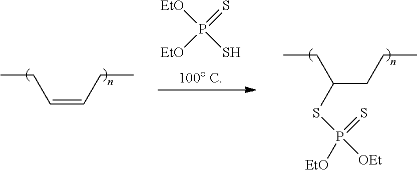

To a pressure vessel equipped with a stir bar was charged polybutadiene (0.33 g, Sigma-Aldrich, Mn˜1500-2000 g/mol by VPO (vapor pressure osmometry)) and O,O′-diethyldithiophosphoric acid (2.3 g). After heating at 100° C. overnight, the solution was diluted with CH₂Cl₂ and washed with a saturated aqueous sodium bicarbonate solution. The organic layer was concentrated under vacuum before precipitation in methanol. The product was obtained as a colorless viscous liquid (0.64 g).

### Synthesis of DTPA-PI

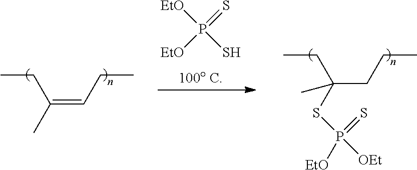

To a pressure vessel equipped with a stir bar was charged polyisoprene (0.18 g, Mw˜35,000 g/mol, from Kuraray) and O,O′-diethyldithiophosphoric acid (0.75 g). After heating at 100° C. overnight, the mixture was precipitated in methanol to obtain the product as a colorless solid (0.43 g).

### Synthesis of DTPA-Guayule

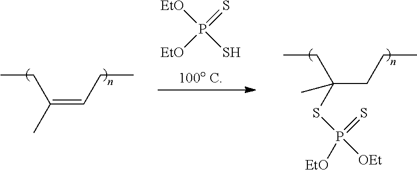

To a pressure vessel equipped with a stir bar was charged Guayule (2.0 g, acetone soluble fraction, Mn˜20000 g/mol) and O,O′-diethyldithiophosphoric acid (15.0 g). After heating at 100° C. overnight, the mixture was diluted with CH₂Cl₂ and washed with saturated aqueous sodium bicarbonate solution. The organic layer was concentrated under vacuum before precipitation in methanol. The product was obtained as a brown solid (3.4 g).

### Synthesis of DTPA-PNB

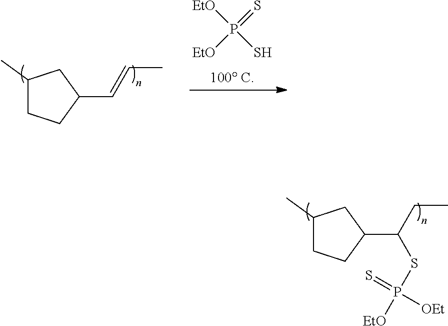

To a pressure vessel equipped with a stir bar was charged polynorbornene (120 mg, Mn˜20000 g/mol) and O,O′-diethyldithiophosphoric acid (3.6 g). After heating at 100° C. overnight, the mixture was diluted with CH₂Cl₂ and washed with saturated aqueous sodium bicarbonate solution. The organic layer was concentrated under vacuum before precipitated in methanol. The product was obtained as a light pink solid (265 mg).

### Example 2—Experimental Procedures

### Synthesis of dialkyldithiophosphoric acids from phosphorus decasulfide

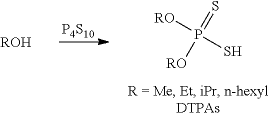

Dithiophosphoric acids with different alkyl groups (methyl, isopropyl, n-hexyl) were successfully synthesized by treatment of P₄S₁₀ with the corresponding alcohols under moderate heat. The synthesized DTPAs were all miscible liquids at room temperature, which ensured they could act as both solvent and reactant in the proposed polyolefin addition reactions, thereby negating the need for a co-solvent. A major benefit of this “solvent-free” approach is that unreacted DTPAs can be removed via extraction due to their different physical properties (strong protic acids) compared to the neutral adducts, making the processing and purification less challenging.

General Procedure A for the Synthesis of Dithiophosphoric Acids: A flame-dried 25 ml RBF equipped with a stir bar and condenser was charged with the corresponding alcohols (70 mmol). Phosphorus pentasulfide (20 mmol) was added in one portion at 0° C. and the liberating gases were scrubbed with a bleach solution. After the vigorous bubbling stopped, the ice bath was removed, and the reaction mixture was heated to a certain temperature for 3 hours. After cooling to room temperature, the remaining solid was filtered off to provide the desired dithiophosphoric acid as a colorless to pale yellow liquid. The spectral data for the crude product matched with what being reported before (See, B. Guo, J. T. Njardarson, Chem. Commun. 2013, 49, 10802-10804) and was used for polymer functionalization without further purification.

### Synthesis of PI-g-DTPs (Polyisoprene (PI) functionalization)

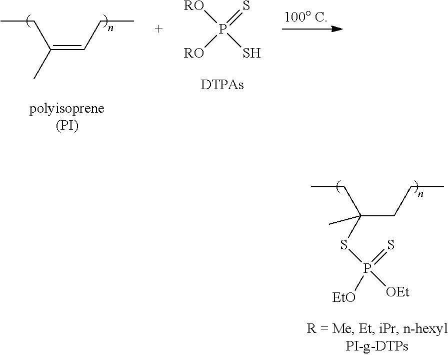

The initial DTPA addition studies utilized soluble liquid polyisoprene (PI; Mn=15,400 g/mol, Mw/Mn=2.21, courtesy of Kuraray) to ensure good miscibility with DTPAs (R=Me, Et, i-Pr). n-hexyl) and use of neat bulk media for the reaction. Since the diethyl DPTA is inexpensive and commercially available, model reactions with PI were the focus of structural NMR spectroscopy studies, where DTPA modified PIs with the different DTPAs shown above were named and abbreviated as polyisoprene-graft-dialkyl dithiophosphate (PI-g-DA-DPT, where DA=dimethyl, diethyl, di-isopropyl, dihexyl; DPT=dithiophosphate). These studies revealed that 2 equivalents of DTPA (per alkene from PI) was sufficient to efficiently dissolve the polymer fluid where the electrophilic addition proceeded in 2-6 hours at 100° C. depending on the alkyl DTPA of choice. Purification of the DTPA functionalized PI was achieved by simple aqueous workup (to remove excess DTPAs) and precipitation into methanol.

General Procedure C for the functionalization of Polyisoprene: To a vial equipped with a stir bar was charged with polyisoprene (Mₙ=15,400 g/mol, 100 mg) and respective dithiophosphoric acids (1.0 g). The mixture was then heated to 100° C., at which point a colored homogeneous solution was observed, and the reaction was monitored by ¹H NMR which was taken of an aliquot of the reaction mixture. Once full conversion of the polyisoprene was confirmed after 2-6 hours, the reaction was cooled to room temperature, diluted with DCM, and washed with saturated aqueous sodium bicarbonate solution. The organic layer was separated and concentrated under reduced pressure. After redissolving in 1 ml THF, the polymer was precipitated in 10 ml MeOH to remove unreacted residual reagents (Repeat for 3 times). The precipitated final product was suction filtered by the filter paper and dried at 60° C. in a convection oven for 24 hrs.

PI-g-DM-DTP:

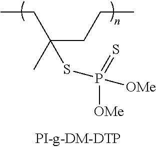

PI-g-DM-DTP was prepared by following general procedure C using dimethyl thiophosphoric acid. Yield: 250 mg, colorless to pale yellow solid. ³¹P NMR (202 MHz, CDCl₃) δ 95.31. Mₙ=10.5 k g/mol, M_{w}=15.1 k g/mol, PDI=1.44. T_{d onset}=124.18° C., T_{d 5% weight loss}=130.82° C., Residual Weight at 800° C.=4.11%.

PI-g-DE-DPT:

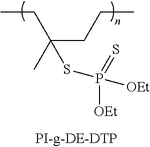

PI-g-DE-DTP was prepared by following general procedure C using diethyl thiophosphoric acid. Yield: 265 mg, colorless to white solid. Mₙ=26.6 k g/mol, M_{w}=51.0 k g/mol, PDI=1.91. T_{d onset}=148.39° C., T_{d 5% weight loss}=150.72° C., Residual Weight at 800° C.=0.20%.

PI-g-DI-DPT:

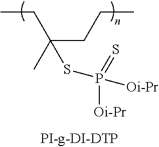

PI-g-DI-DTP was prepared by following general procedure C using diisopropyl thiophosphoric acid. Yield: 350 mg, colorless to white solid. ³¹P NMR (202 MHz, CDCl₃) δ 87.30. Mₙ=42.2 k g/mol, M_{w}=73.6 k g/mol, PDI=1.74. T_{d onset}=130.75° C., T_{d 5% weight loss}=140.93° C., Residual Weight at 800° C.=16.34%.

PI-g-DH-DPT:

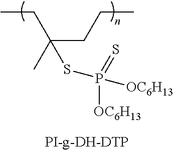

PI-g-DH-DTP was prepared by following general procedure C using dihexyl thiophosphoric acid. Yield: 380 mg, pale yellow rubbery solid. ³¹P NMR (202 MHz, CDCl₃) δ 90.54. Mₙ=28.0 k g/mol, M_{w}=49.3 k g/mol, PDI=1.76. T_{d onset}=160.31° C., T_{d 5% weight loss}=173.56° C., Residual Weight at 800° C.=7.39%.

Representative ¹H NMR spectra of PI before and after diethyl-DTPA addition clearly showed complete consumption of olefinic products (Hₐ, δ=5.15 ppm) and exclusive formation of the Markovnikov addition product, as evidenced by the absence of downfield methylene protons from —S—CH₂— moieties.

³¹P NMR spectroscopy also confirmed regioselective addition of PI, with PI-g-DE-DTP affording a single resonance at (90 ppm), which was downfield from the resonance for the diethyl DTPA starting material (δ=86 ppm,). These results indicate that the newly formed C—S bond was selectively formed on the tertiary carbon, supporting the electrophilic addition mechanism posited earlier, which is also the case for the other DTPAs (DA=dimethyl, diethyl, di-isopropyl, dihexyl) reacted with PI. This facile, complete, and selective PI addition of a sulfur functional group (DTPA) and a hydrogen across the double bonds of PI stands in contrast to conventional thiol-ene polyolefin additions, which form the C—S bond at the secondary carbon and commonly struggle to achieve complete addition while also requiring a solvent for the reaction. Furthermore, all the PI-graft-DTPs prepared from this dialkyl DTPA series were soluble in conventional organic media. Size exclusion chromatography (SEC) in tetrahydrofuran (THF) of the diethyl DTPA-functionalized PI indicated marginal changes in the apparent molar mass and polydispersity compared to the native PI, which confirms that the proposed mechanistic pathway proceeded without incident of crosslinking or generation of undesirable reactive intermediates.

The effect of polyisoprene functionalization with DTPA groups were observed to afford significant bulk property changes (thermomechanical and optical) vs the pristine liquid polydiene substrate. DTPA side chain groups on PIs afforded rubbery materials possessing low T_{g} as noted by differential scanning calorimetry (DSC), where the T_{g}'s increased significantly with aliphatic DTPA moieties (PI-g-DE-DTP, T_{g}=−49° C. vs PI-g-DM-DTP, T_{g}=6° C.). However, it is clear that the addition of DTPA groups raised T_{g} and thermomechanical properties vs the initial PI (Mₙ=15,400 g/mol) which was a polymer fluid. Small amplitude oscillatory rheology most dramatically confirmed the effects of DTPA incorporation to PI as observed in the rheology of the PI-g-DE-DTP vs the liquid PI starting material, where time-temperature superposition (TTS) was successful for both materials, but a 60° C. higher reference temperature was required for the PI-g-DE-DTP as a consequence of chain stiffening from DTPA grafting. These point to the non-covalent, dipolar associations from the side chain dithiophosphonate groups, which notably enabled solution processing of these materials into flexible free-standing films. Tensile testing of solution cast films of PI-g-DE-DTP afforded low strength, ductile materials (4 MPa tensile strength, 396% elongation at break). The UTS was attributed to the fairly low molar mass of the liquid model PI substrate used for this study, but is sufficient evidence of significant mechanical strength enhancement as the starting PI substrate was a polymer fluid (and hence not measurable).

DTPA incorporation to PI also dramatically affected the optical properties of the final material (e.g., refractive index), due to the high content of polarizable, heteroatoms in each DTPA group. Optical properties of DTPA modified PI series were also evaluated by thin film ellipsometry measurements. Ellipsometry confirmed a progressive increase in RI for all of the DTPA grafted polyisoprenes relative to native PI due to the inclusion of polarizable heteroatoms (n=1.49-1.56 at 586 nm) along with a relatively high Abbe Number (V_{d}˜33-34). Higher refractive index values (n˜1.57-1.60) were observed in the visible spectrum for the PI-g-DM-DTP possessing smaller methyl groups as expected, since larger aliphatic units with more hydrocarbons decrease RI.

### Synthesis of pNB-g-DTPs (Polynorbornene (pNB) Functionalization)

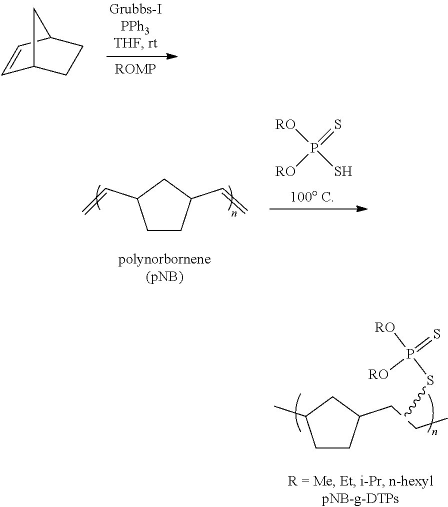

To further demonstrate the scope of the DTPA addition process, the functionalization of ROMP synthesized pNB by dissolution of the polymer in neat DTPAs (Me, Et, i-Pr, n-hexyl). For these studies, the polynorbornene substrate was prepared by ROMP of norbornene using Grubbs-I catalyst (benzylidene-bis(tricyclohexylphosphino)-dichlororuthenium) in the presence of triphenylphosphine and quenched with methyl vinyl ether, yielding a well-defined homopolymer as confirmed by SEC in THF (Mn=20,000; Mw/Mn=1.03). The resulting pNB homopolymer was then dissolved in neat DTPA (Me, Et, iPr or n-hexyl) and heated at 100° C. overnight to drive the electrophilic addition to completion, followed by identical purification process as employed for DTPA additions to PI.

General Procedure D for the functionalization of Polynorbornene: To a vial equipped with a stir bar was charged with polynorbornene (Mn=20,000 g/mol, 100 mg) and respective dithiophosphoric acids (2.5 g). The mixture was then heated to 100° C., at which point a colored homogeneous solution was observed and the reaction was stirred overnight. After cooling to room temperature, the reaction mixture was diluted with DCM and washed with saturated aqueous sodium bicarbonate solution. The organic layer was separated and concentrated under reduced pressure. After redissolving in 1 ml THF, the polymer was precipitated in 10 ml MeOH to remove unreacted residual reagents (Repeat for 3 times). The precipitated final product was suction filtered by the filter paper and dried at 60° C. in a convection oven for 24 hrs.

pNB-g-DM-DPT:

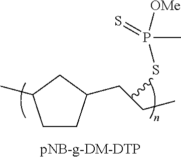

pNB-g-DM-DTP was prepared by following general procedure D using dimethyl thiophosphoric acid. Yield: 280 mg, pale yellow solid. ³¹P NMR (202 MHz, CDCl₃) δ 102.10. Mₙ=20.0 k g/mol, M_{w}=21.1 k g/mol, PDI=1.05. T_{d onset}=135.69° C., T_{d 5% weight loss}=162.99° C., Residual Weight at 800° C.=13.23%.

pNB-g-DE-DPT:

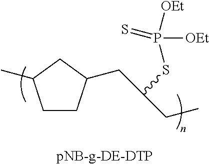

pNB-g-DE-DTP was prepared by following general procedure D using dimethyl thiophosphoric acid. Yield: 305 mg, pale yellow solid. ³¹P NMR (202 MHz, CDCl₃) δ 97. Mₙ=26.7 k g/mol, M_{w}=28.8 k g/mol, PDI=1.09. T_{d onset}=136.31° C., T_{d 5% weight loss}=212.14° C., Residual Weight at 800° C.=13.71%.

pNB-g-DI-DPT:

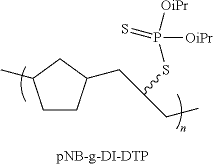

pNB-g-DI-DTP was prepared by following general procedure D using diisopropyl thiophosphoric acid. Yield: 295 mg, pale yellow solid. Mₙ=24.5 k g/mol, M_{w}=28.2 k g/mol, PDI=1.15. T_{d onset}=91.79° C., T_{d 5% weight loss}=158.40° C., Residual Weight at 800° C.=13.29%.

pNB-g-DH-DPT:

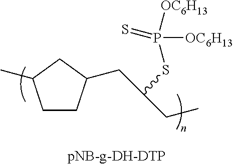

pNB-g-DH-DTP was prepared by following general procedure D using dihexyl thiophosphoric acid. Yield: 370 mg, pale yellow solid. ³¹P NMR (202 MHz, CDCl₃) δ 97.95. Mₙ=34.2 k g/mol, M_{w}=35.4 k g/mol, PDI=1.04. T_{d onset}=149.59° C., T_{d 5% weight loss}=216.37° C., Residual Weight at 800° C.=13.57%.

NMR spectroscopic analysis of the DTPA-grafted pNBs confirmed quantitative consumption of olefinic protons on the polymer backbone, along with observation of major ³¹P NMR resonances, both of which confirmed quantitative functionalization of double bonds in the polymer backbone. Representative ¹H and ³¹P NMR spectra of polynorbornene before and after diethyl DTPA addition, where both trans- and cis internal olefinic protons from pNB (Hₐ, Hb, 6=5.23 and 5.37 ppm) are fully consumed after treatment in neat diethyl DTPA, an observation of new —O—CH₂—CH₃ fragments from the DTPA sidechain are observed (H_{a′}, δ=4.12 ppm; H_{g}, 6=1.33 ppm). ³¹P NMR spectra of the isolated pNB-g-DE-DTP contains only a broad overlapped set of peaks at δ=97 ppm, which is significantly farther downfield to the diethyl DTPA starting material (δ=85 ppm). The other dialkyl DTPAs also were found to quantitatively add to the olefinic group of pNB with similar NMR spectroscopic features. While the NMR spectroscopic analysis of these pNB-g-DTPs were quantitative, the regioisomeric mixtures of polymer microstructure were observed as the DTPA group can add to either carbon site of the internal PNB olefins. The pNB-g-DA-DTP materials were all found to be soluble and amenable to SEC-THF analysis which indicated slight increases in molar mass and comparable polydispersity post-functionalization.

DSC analysis of the pNB-g-DTPs demonstrated the formation of rubbery polymers with lower Tg's compared to starting pNB polymer, where these Tg values ranged from −44° C. (for hexyl-functionalized DTPA) to 22° C. (for ethyl-functionalized DTPA). It is noteworthy that the presence of longer alkyl side chains on the DTPA groups contributed to a decrease in the glass transition temperature, indicating a greater flexibility and rubbery behavior in the resulting polymers. Ellipsometry measurements confirmed a progressive increase in RI because of the of the high content of polarizable atoms in the DTPA moiety throughout the polymer backbone. The RI (n=1.52-1.55) was readily tunable by functionalization with DTPA of varying alkyl segment length and size at 586 nm.

### Synthesis of p(DTP-NB)-g-DTPs

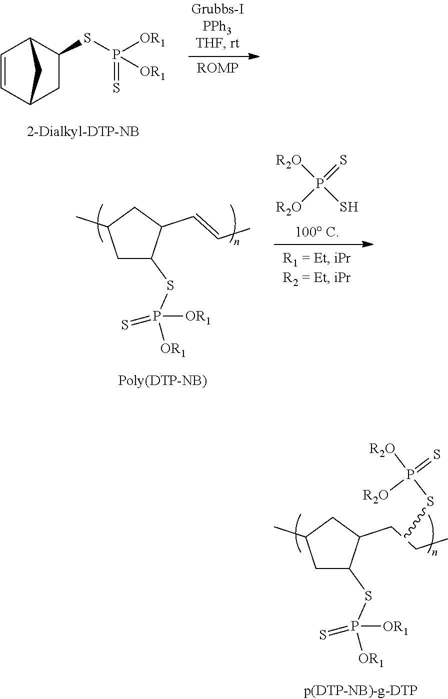

To further augment the functionality of the newly DTPA-decorated polymers, a DTPA functional norbornene monomer was synthesized to prepare dialkyl dithiophosphate side chain functional polynorbornenes via ROMP, followed by post-polymerization acidic electrophilic addition of the poly-ene backbone with the second DTPA homopolymers as depicted above. DTPA starting materials with either ethyl or isopropyl groups (R₁=Et, iPr) were used here for addition to norbornadiene to prepare the DA-DTP monomer, or for a second post-polymerization functionalization step where different dialkyl DTPA combinations were employed to enable structural characterization of both steps using NMR spectroscopy. ROMP of either the diethyl-dithiophosphate norbornene (DE-DTP-NB), or the diisopropyl-substituted substrate (DI-DTP-NB) was conducted in solution using the Grubbs-I catalyst. Notably, a significant difference in reactivity between Diethyl-dithiophosphate norbornene (DE-DTP-NB) and the diisopropyl-substituted substrate (DI-DTP-NB) was observed, where the DI-DTP-NB proceeded to complete monomer conversion within an hour, whereas DE-DTP-NB reached 80% conversion over a much longer reaction time of six hours. SEC of both poly(DE-DTP-NB) (Mn=8,400 g/mol; Mw/Mn=2.20) and poly(DI-DTP-NB) (Mn=72,200 g/mol; Mw/Mn=1.60)) was conducted, which corroborated the beneficial steric effects observed in the ROMP rate enhancement of these monomers correlated to significantly higher molar masses achieved for the poly(DI-DTP-NB) homopolymer. Ongoing efforts are focused on optimizing conditions for achieving higher molecular weight and narrower polydispersity. Nevertheless, both of the dialkyl dithiophosphate functional polynorbornenes were of sufficiently high molar mass to proceed with the second acidic electrophilic addition of the corresponding DTPA with alternate dialkyl moieties as shown above.

General Procedure B for the Synthesis of Dialkyl dithiophosphate norbornenes (DA-DTP-NB): This procedure was slightly modified from the previous report (See, D. Fabbri, G. Delogu, 0. De Lucchi, Tetrahedron: Asymmetry 1993, 4, 1591-1596). To a 100 ml RBF equipped with a stir bar was charged with dithiophosphoric acids (9.0 mmol), followed by the addition of DCM (20 ml). A solution of norbornadiene (100 mmol) in DCM (15 ml) was added slowly and the resulting solution was stirred at room temperature overnight. After being concentrated under reduced pressure, the crude product was purified by flash column chromatography (silica gel, 5% EtOAc in hexanes) to afford the desired products as colorless liquid.

DE-DTP-NB:

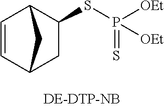 [SMILES: CCOP(=S)(OCC)S[C@H]1C[C@@H]2C=C[C@H]1C2]

DE-DTP-NB was prepared by following general procedure B using diethyl thiophosphoric acid. Yield: 2.12 g, 85%, colorless oil. ¹H NMR (500 MHz, CDCl₃) δ 6.13 (dd, J=5.7, 2.9 Hz, 1H), 6.06 (ddd, J=5.7, 3.1, 0.7 Hz, 1H), 4.32-4.07 (m, 4H), 3.08-2.99 (m, 1H), 2.98 (t, J=1.7 Hz, 1H), 2.90 (d, J=3.0 Hz, 1H), 1.77-1.68 (m, 1H), 1.62-1.56 (m, 1H), 1.56-1.49 (m, 2H), 1.37 (tdd, J=7.0, 4.0, 0.7 Hz, 6H). ¹³C NMR (126 MHz, CDCl₃) δ 138.48, 134.85, 63.96 (dd, J=5.97, 2.16 Hz, 2C), 49.63 (d, J=4.09 Hz, 1C), 46.33, 45.66 (d, J=3.82 Hz, 1C), 41.96, 35.49 (d, J=7.82 Hz, 1C), 16.06 (d, J=8.34 Hz, 1C). ³¹P NMR (202 MHz, CDCl₃) δ 93.59. HRMS (ESI⁺) m/z [(M+H)]+ Calculated mass for C₁₁H₁₉O₂PS₂ 279.0637; Found 279.0640.

DI-DTP-NB:

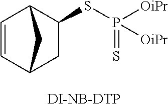

DI-DTP-NB was prepared by following general procedure B using diisopropyl thiophosphoric acid. Yield: 2.36 g, 86%, colorless oil. ¹H NMR (500 MHz, CDCl₃) δ 6.13 (dd, J=5.6, 2.9 Hz, 1H), 6.05 (dd, J=6.0, 3.2 Hz, 1H), 4.85 (dpd, J=12.4, 6.2, 2.1 Hz, 2H), 3.09-3.02 (m, 2H), 2.91-2.87 (m, 1H), 1.72 (ddd, J=11.1, 8.2, 2.3 Hz, 1H), 1.60 (dtd, J=12.4, 3.7, 1.4 Hz, 1H), 1.56-1.47 (m, 2H), 1.36 (dt, J=6.2, 2.0 Hz, 12H). ¹³C NMR (126 MHz, CDCl₃) δ 138.43, 134.91, 73.44 (t, J=7.29 Hz, 2C), 49.56 (d, J=4.08 Hz, 1C), 46.34, 45.84, 41.98, 35.40 (d, J=8.15 Hz, 1C), 23.94 (dd, J=7.59, 4.54 Hz, 2C), 23.70 (dd, J=5.18, 2.16 Hz, 2C). ³¹P NMR (202 MHz, CDCl₃) δ 90.81. HRMS (ESI+) m/z [(M+H)]+ Calculated mass for C₁₃H₂₃O₂PS₂ 307.0950; Found 307.0952.

With the DI-DTP-NB in hand, post-polymerization functionalization of the ene backbone of polynorbornene with a disparate monofunctional DTPA (R=Et, or iPr) was conducted by simple dissolution of the homopolymer in excess neat DTPA as the solvent at elevated temperature (T=100° C.) for 3-6 hours.

General Procedure E for the Synthesis of Poly (Dialkyl-dithiophosphate norbornenes): To a flame-dried 100 ml RBF equipped with a stir bar was charged with Dialkyl dithiophosphate norbornene (10.0 mmol, 1.0 equiv.), followed by the addition of degassed anhydrous DCM (95 ml) at 0° C. After stirring for 5 minutes, a solution of Grubbs-I catalyst (82 mg, 0.1 mmol, 0.01 equiv.) in THF (5 ml) was added dropwise and the reaction mixture was kept at 0° C. for an additional 3 hours. After quenching with ethyl vinyl ether (4.8 ml, 50.0 mmol, 5.0 equiv.), the solution was stirred for another 1 hour before concentrating under reduced pressure. After redissolved in 10 ml THF, the polymer was precipitated in 100 ml MeOH to remove the catalyst and other unreacted residual reagents (Repeat for 3 times). The polymer was collected as a light gray to dark brown solid.

p(DE-DTP-NB):

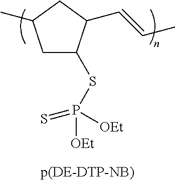

p(DE-DTP-NB) was prepared by following general procedure E. Yield: 760 mg, black solid. Mₙ=8.4 k g/mol, M_{w}=1.9 k g/mol, PDI=2.22. T_{d onset}=206.13° C., T_{d 5% weight loss}=218.30° C., Residual Weight at 800° C.=37.59%.

p(DI-DTP-NB):

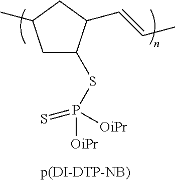

p(DI-DTP-NB) was prepared by following general procedure E. Yield: 1.26 g, black solid. Mₙ=79.2 k g/mol, M_{w}=126.7 k g/mol, PDI=1.60. T_{d onset}=158.33° C., T_{d 5% weight loss}=200.29° C., Residual Weight at 800° C.=30.76%.

General Procedure F for the Functionalization of Poly (Diisopropyl-dithiophosphate norbornene): To a vial equipped with a stir bar was charged with poly(Diisopropyl-dithiophosphate norbornene) (Mn=79,000 g/mol, 100 mg) and respective dithiophosphoric acids (2.5 g). The mixture was then heated to 100° C., at which point a colored homogeneous solution was observed, and the reaction was stirred overnight. After cooling to room temperature, the reaction mixture was diluted with DCM and washed with saturated aqueous sodium bicarbonate solution. The organic layer was separated and concentrated under reduced pressure. After redissolving in 1 ml THF, the polymer was precipitated in 10 ml MeOH to remove unreacted residual reagents (Repeat for 3 times). And the precipitated final product was suction filtered by the filter paper and dried at 60° C. in a convection oven for 24 hrs.

p(DI-DTP-NB)-g-DE-DTP:

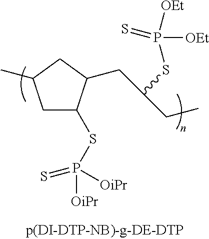

p(DI-DTP-NB)-g-DE-DTP was prepared by following general procedure F. Yield: 150 mg, yellow solid. Mₙ=63.7 k g/mol, M_{w}=136.4 k g/mol, PDI=2.14. T_{d onset}=190.87° C., T_{d 5% weight loss}=193.18° C., Residual Weight at 800° C.=1.12%.

p(DI-DTP-NB)-g-DI-DTP:

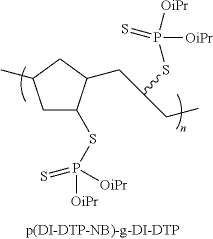

p(DI-DTP-NB)-g-DI-DTP was prepared by following general procedure F. Yield: 155 mg, yellow solid. Mₙ=15.1 k g/mol, M_{w}=22.0 k g/mol, PDI=1.45. T_{d onset}=122.50° C., T_{d 5% weight loss}=154.38° C., Residual Weight at 800° C.=26.34%.

Both ¹H and ³¹P NMR spectroscopy of the resulting adducts confirmed incorporation of different DTPAs in the NB side chain or pNB main chain for both different materials combinations, where the ³¹P NMR spectroscopy provided the clearest evidence of differential DTPA incorporation. ³¹P NMR spectra showed a progressive downfield shift of the ³¹P resonances was observed for the diethyl DTPA (6=85 ppm) vs the ROMP synthesized poly(DI-DTP-NB) (6=93 ppm), where after addition of diethyl DTPA to olefinic backbone groups, two distinct peaks for each DTPA group are observed (6=93 ppm, 95 ppm). In general, the 2nd electrophilic addition of DTPAs to polynorbornenes with DTPA side chain groups did not proceed to completion as for the case of pNB homopolymers, where ¹H NMR spectroscopic monitoring of these reactions indicated around 50-88% functionalization of the 2nd DTPA addition was observed. ¹H NMR spectrum of the poly(diisopropyl-dithiophosphate-norbornene)-graft-diethyl-dithiophosphate (poly(DI-DTP-NB)-g-DE-DTP) proceeded to around 82% conversion of olefinic groups. The impact on the bulk thermal and optical properties after the 2nd DTPA functionalization step were not dramatically different than those polynorbornenes carrying a singe dialkyl dithiophosphate group per repeating unit of the polymer since the molar fraction (mol %) of phosphorus and sulfur in the polymer did not dramatically change. Nevertheless, this synthetic demonstration points to the versatility of this DTPA family of compounds for polymer functionalization.

### Polyisoprene Vulcanization with DTPAs

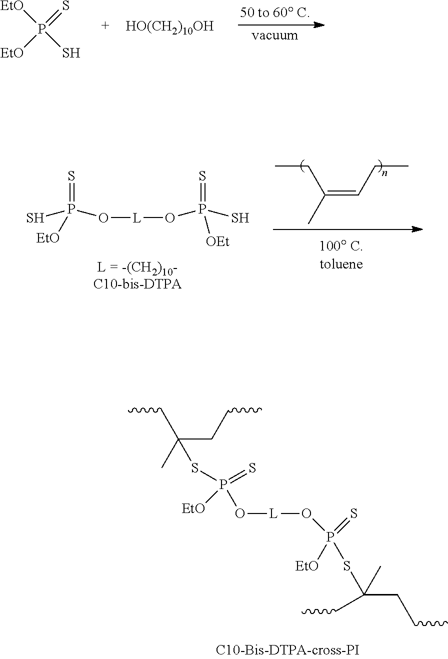

The potential of these inexpensive DTPAs to prepare new materials from polydienes was further elaborated upon by the synthesis of di-functional DTPAs and crosslinking of linear soluble polyisoprenes (Mₙ=15,400 g/mol) as an alternative to classical insoluble sulfur vulcanization agents. A notable chemical difference using bis-DTPA vs classical insoluble sulfur crosslinking agents would be in the crosslinking chemistry to polyisoprene, which for DTPAs proceeds by electrophilic addition to the olefinic backbone. Toward that end, a bis-functional DTPA was prepared by transesterification between 1,10-decanediol and diethyl-DTPA to afford C₁₀-bis-DTPA as shown above. This new crosslinker was next reacted with polyisoprene (Mₙ=15,400 g/mol).

Synthesis of C₁₀-bis-DTPA: To a flame-dried flask equipped with a stir bar was added freshly distilled DE-DTPA (23.19 g, 2.0 equiv.) and 1,10-dedecanediol (10.85 g, 1 equiv.). The reaction was then heated at 50° C. under vacuum and the distillate was collected in a trap cooling with dry ice/acetone bath. After fully dissolving the solid diols after 1 h, the temperature was increased to 60° C. and vigorously bubbling was observed. After kept at 60° C. for 1 h, the reaction was heated to 70° C. for 4 hours until the rate of bubbling was reduced. The vacuum was then stopped, and the reaction was heated at 75° C. overnight under N2 atmosphere. The C₁₀-bis-DTPA was collected as a pale green oil (25.2 g) and used without further purification.

C₁₀-bis-DTPA:

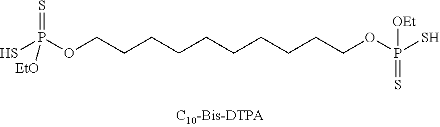 [SMILES: CCOP(=S)(S)OCCCCCCCCCCOP(=S)(S)OCC]

Yield: 2.12 g, 85%, colorless oil. ¹H NMR (500 MHz, CDCl₃) δ 4.24 (dqd, J=10.2, 7.1, 1.2 Hz, 4H), 4.15 (dtd, J=9.3, 6.6, 1.9 Hz, 4H), 1.73 (p, J=6.8 Hz, 4H), 1.45-1.25 (m, 18H). ¹³C NMR (126 MHz, CDCl₃) δ 68.56, 64.53, 30.01, 29.52, 29.23, 25.66, 15.98. ³¹P NMR (202 MHz, CDCl₃) δ 85.29. HRMS (ESI+) m/z [(M+H)]+ Calculated mass for C14H33O4P2S4 455.0731; Found 455.0728.

To fabricate vulcanized crosslinked films, solution formulations were required to enable efficient homogenization of the C₁₀-bis-DTPA (varying loadings of 5, 10 and 12.5-mol % of C₁₀-bis-DTPA vs number of olefinic PI groups). C₁₀-bis-DTPA was reacted with PI in toluene at low conversion of vinyl groups, then solution cast into films and thermally cured at T=50° C. to drive crosslinking. This process afforded well-defined crosslinked films for all three C₁₀-bis-DTPA loadings (5, 7.5 and 12.5-mol %), which allowed for facile determination to thermomechanical structure-property effects.

General Procedure for Polyisoprene Vulcanization with bis-DTPAs: To a flame-dried flask equipped with a stir bar was added polyisoprene (Mn=15,400 g/mol) and 5, 7.5 or 12.5 mol % of C₁₀-bis-DTPA (Calculated based on the number of olefinic groups in polyisoprene). Then 50 ml of toluene was added and the solution was heated at 100° C. for 45 to 60 minutes before vitrification. The solution was filtered through a filter paper while still warm and transferred into a petri dish. The solvent was slowly removed on a hot plate at 60° C. over 2 days to obtain the film.

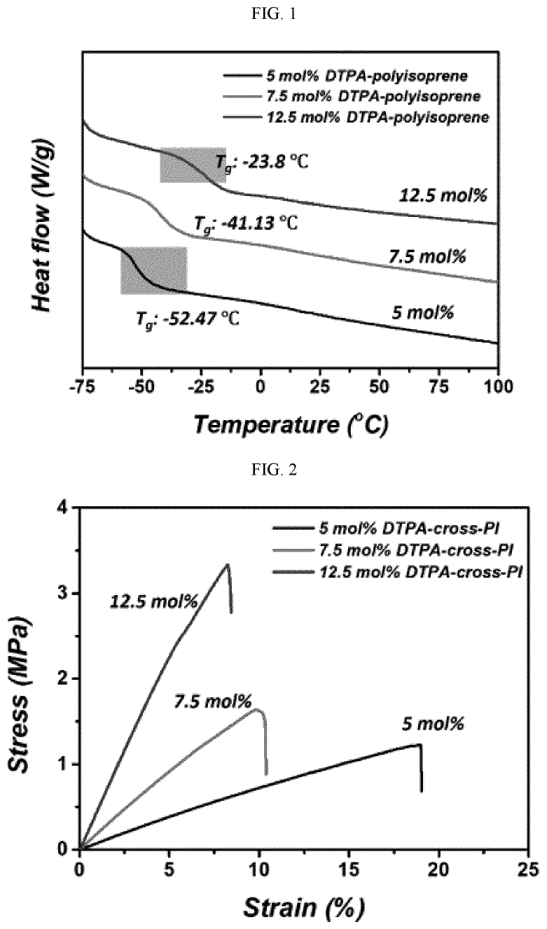

DSC of DTPA crosslinked film showed a progressive increase in T_{g} with higher DTPA loading (FIG. 1), along with a progressive increase in tensile strength ranging from 1-3 MPa and 8-19% elongation at break (FIG. 2). This demonstration of tuning mechanical properties with DTPAs as the vulcanizing agent for PI is significant given how the electrophilic addition chemistry chemistry of crosslinking is profoundly different than observed for S₈ vulcanization methods. The overall tensile strength of the crosslinked materials is fairly low, due to the low molar mass of the soluble PI used vs intrinsic issues with DTPA crosslinking chemistry.

### Flame Retardancy Test of PI-g-DE-DTPA

Due to the low cost and commercial availability of diethyl-DTPA and the soluble linear polyisoprene, the synthesis and processing of PI-g-DE-DTP was conducted to enable large scale solution casting of free standing polymer films to demonstrate the flame retardant (FR) properties of these materials.

Flame-retardant properties were tested according to the ASTM D3801 standard. The torch was controlled to produce a blue flame with a 20 mm high central cone. The flame was applied to the bottom of the specimen and the top of the torch was placed at 10 mm from the bottom edge of the specimen. During the test, a piece of cotton was placed under the specimen. The flame was applied for 10 s and removed. Once the flame was extinguished, the flame was applied again with same process. During the flame test, the torch was tilted through an angle of 450 for checking the flame spreading of drops fall to the cotton.

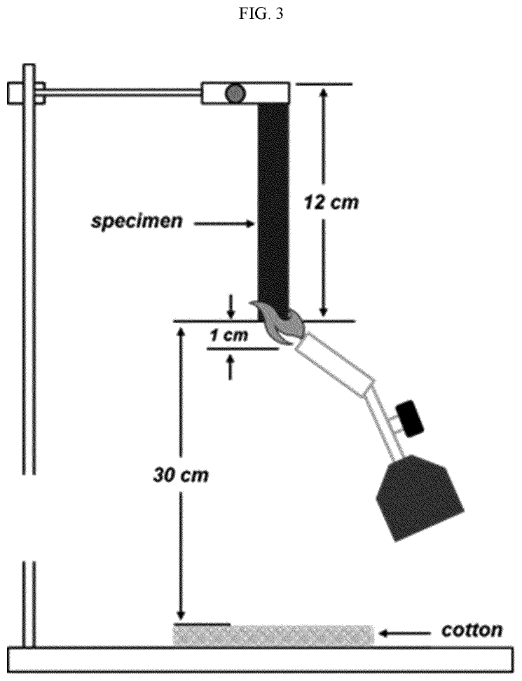

A UL-94 vertical flame retardancy test was employed following the standard procedure (see FIG. 3) and observed rapid self-extinguishing within 1 second during both the first and second ignition, without ignition of the cotton bed underneath. These results confirmed that the incorporation of DTPAs with a high heteroatom content (˜30 wt % sulfur, 15-wt % phosphorus) imparted FR properties of the polydiene substrate which achieved the highest “V0” FR rating in the UL-94 flame-retardancy test. It is presumed here that the DTPA impacts FR properties via a vapor phase mechanism, which is comparable to high sulfur content polymers derived from inverse vulcanization.

In conclusion, these examples demonstrate polymer functionalization utilizing the electrophilic addition of DTPAs to polydienes. DTPAs are sourced from elemental sulfur and phosphorous and can be identified as a sulfur derived commodity chemical that is inexpensive and readily prepared into various mono-, or di-functional DTPAs. High reactivity and selectively of this compound for quantitative functionalization of challenging polyenes, namely PI and pNB, are shown by these examples. Furthermore, the high content of polarizable heteroatoms into a well-defined functional group is demonstrated to impart intriguing bulk properties, namely higher refractive index, and flame retardancy. Finally, the ability to prepare crosslinked polydiene films with di-functional DTPAs, where the crosslinking density and thermomechanical properties can be directly tuned by DTPA feed ratios, is demonstrated.
Para 1. A composition comprising a reaction product of a polymer comprising one or more olefins and a dithiophosphoric acid compound of Formula (I) or Formula (II):

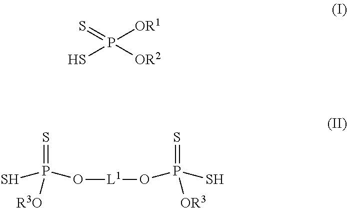

wherein:
R¹ and R² are each individually alkyl, heteroalkyl, cycloalkyl, heterocyclyl, aryl, heteroaryl, or aralkyl; or
R¹ and R² are joined together with the oxygen atoms to which they are attached and any intervening atoms to form a ring,
each R³ is individually alkyl, heteroalkyl, cycloalkyl, heterocyclyl, aryl, heteroaryl, or aralkyl; and
L¹ is alkylene.
Para. 2. The composition of Para. 1, wherein the compound is of Formula (I).
Para. 3. The composition of Para. 2, wherein R¹ and R² are each individually alkyl.
Para. 4. The composition of Para. 3, wherein R¹ and R² are each individually methyl, ethyl, or isopropyl.
Para. 5. The composition of Para. 2, wherein R¹ and R² are joined together with the oxygen atoms to which they are attached and any intervening atoms to form a ring.
Para. 6. The composition of Para. 5, wherein R¹ and R² are joined together with the oxygen atoms to which they are attached and any intervening atoms to form a six membered ring.
Para. 7. The composition of Para. 2, wherein the dithiophosphoric acid compound is any one of the following:

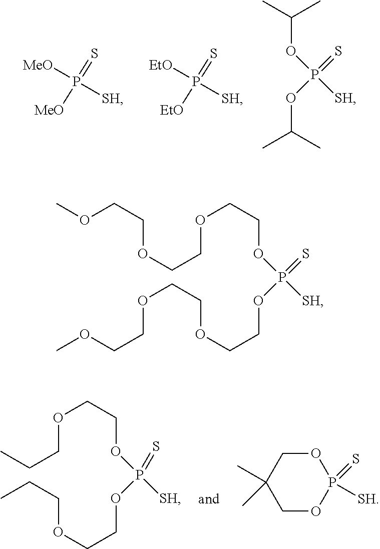

Para. 8. The composition of Para. 1, wherein the compound is of Formula (II).
Para. 9. The composition of Para. 8, wherein each R³ are individually alkyl.
Para. 10. The composition of Para. 9, wherein each R³ are individually methyl, ethyl, or isopropyl.
Para. 11. The composition of any one of Paras. 8-10, wherein L¹ is C₄ to C₂₀ alkylene.
Para. 12. The composition of Para. 11, wherein L¹ is C₆ alkylene, C₁₀ alkylene or C₁₂ alkylene.
Para. 13. The composition of Para. 8, wherein the dithiophosphoric acid compound is any one of the following:

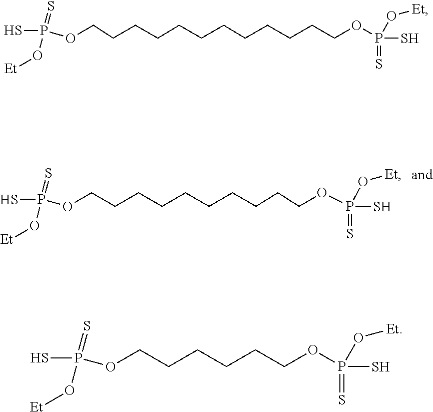 [SMILES: CCOP(=S)(S)OCCCCCCCCCCCCOP(=S)(S)OCC ; CCOP(=S)(S)OCCCCCCCCCCOP(=S)(S)OCC ; "and" ; CCOP(=S)(S)OCCCCCCOP(=S)(S)OCC]

Para. 14. The composition of any one of Paras. 1-13, wherein the polymer comprising one or more olefins is a reaction product of a ring-opening metathesis polymerization of a cycloalkene or norbornene.
Para. 15. The composition of Para. 14, wherein the cycloalkene is a strained olefin.
Para. 16. The composition of Para. 14, wherein the polymer comprising one or more olefins is polynorbornene.
Para. 17. The composition of Para. 16, wherein the polynorbornene comprises a dithiophosphoric acid moiety and has the following formula of:

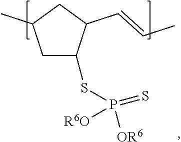

wherein each R⁶ is independently alkyl, heteroalkyl, cycloalkyl, heterocyclyl, aryl, heteroaryl, or aralkyl.
Para. 18. The composition of any one of Paras. 1-13, wherein the polymer comprising one or more olefins is polybutadiene or polyisoprene.
Para. 19. The composition of Para. 18, wherein the polyisoprene is cis-1,4-polyisoprene.
Para. 20. The composition of any one of Paras. 1-7, 14-16, and 18-19, wherein the reaction product is of the formula:

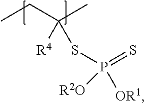

wherein R⁴ is alkyl, heteroalkyl, cycloalkyl, heterocyclyl, aryl, heteroaryl, or aralkyl, or

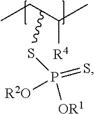

wherein R⁴ is hydrogen.
Para. 21. The composition of any one of Paras. 1, 8-16, and 18-19, wherein the reaction product is of the formula:

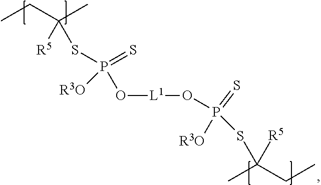

wherein each R⁵ is independently alkyl, heteroalkyl, cycloalkyl, heterocyclyl, aryl, heteroaryl, or aralkyl, or

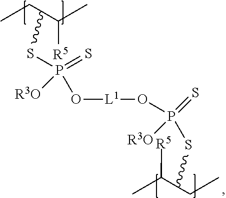

wherein each R⁵ is independently hydrogen.

Para. 22. An article of manufacture comprising a reaction product of any one of Paras. 1-21.

Para. 23. A fire retardant composition comprising a reaction product of any one of Paras. 1-21.

Para. 24. An optical polymer composition comprising a reaction product of any one of Paras. 1-21.

Para. 25. A method for making a reaction product of a polymer comprising one or more olefins and a dithiophosphoric acid compound of Formula (I) or Formula (II):

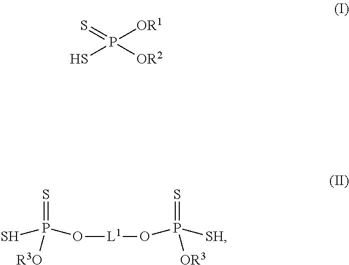

the method comprising:
contacting the polymer comprising one or more olefins with the dithiophosphoric acid;
wherein:
   R¹ and R² are each individually alkyl, heteroalkyl, cycloalkyl, heterocyclyl, aryl, heteroaryl, or aralkyl; or
   R¹ and R² are joined together with the oxygen atoms to which they are attached and any intervening atoms to form a ring;
   each R³ are individually alkyl, heteroalkyl, cycloalkyl, heterocyclyl, aryl, heteroaryl, or aralkyl; and
   L¹ is alkylene.
Para. 26. The method of Para. 25, wherein contacting the polymer comprising one or more olefins with the dithiophosphoric acid does not require a solvent.
Para. 27. The method of Para. 25 or 26, wherein the dithiophosphoric acid is used as the solvent or solubilizer.
Para. 28. The method of any one of Paras. 25-27, wherein contacting the polymer comprising one or more olefins with the dithiophosphoric acid requires heating of at least about 80° C.
Para. 29. The method of Para. 28, wherein contacting the polymer comprising one or more olefins with the dithiophosphoric acid requires heating of about 100° C.
Para. 30. A composition comprising a reaction product of a polymer comprising one or more olefins and a dithiophosphoric acid compound of Formula (I):

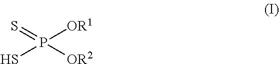

wherein:
R¹ and R² are each individually alkyl, heteroalkyl, cycloalkyl, heterocyclyl, aryl, heteroaryl, or aralkyl; or
   R¹ and R² are joined together with the oxygen atoms to which they are attached and any intervening atoms to form a ring.
Para. 31. The composition of Para. 30, wherein R¹ and R² are each individually alkyl.
Para. 32. The composition of Para. 31, wherein R¹ and R² are each individually methyl, ethyl, or isopropyl.
Para. 33. The composition of Para. 30, wherein R¹ and R² are joined together with the oxygen atoms to which they are attached and any intervening atoms to form a ring.
Para. 34. The composition of Para. 33, wherein R¹ and R² are joined together with the oxygen atoms to which they are attached and any intervening atoms to form a six membered ring.
Para. 35. The composition of Para. 30, wherein the dithiophosphoric acid compound is any one of the following:

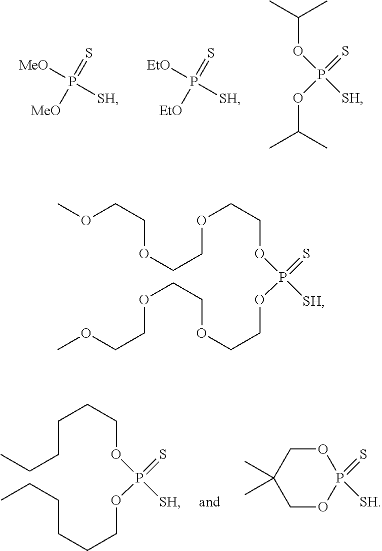

Para. 36. The composition of any one of Paras. 30-35, wherein the polymer comprising one or more olefins is a reaction product of a ring-opening metathesis polymerization of a cycloalkene or norbornene.
Para. 37. The composition of Para. 36, wherein the cycloalkene is a strained olefin.
Para. 38. The composition of Para. 36, wherein the polymer comprising one or more olefins is polynorbornene.
Para. 39. The composition of Para. 36, wherein the polymer comprising one or more olefins is polybutadiene or polyisoprene.
Para. 40. The composition of Para. 39, wherein the polyisoprene is cis-1,4-polyisoprene.
Para. 41. The composition of Para. 30, wherein the reaction product is of the formula:

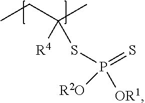

wherein R⁴ is hydrogen, alkyl, heteroalkyl, cycloalkyl, heterocyclyl, aryl, heteroaryl, or aralkyl.
Para. 42. An article of manufacture comprising a reaction product of any one of Paras. 30-41.
Para. 43. A fire retardant composition comprising a reaction product of any one of Paras. 30-41.
Para. 44. An optical polymer composition comprising a reaction product of any one of Paras. 30-41.
Para. 45. A method for making a reaction product of a polymer comprising one or more olefins and a dithiophosphoric acid compound of Formula (I}, the method comprising:
contacting the polymer comprising one or more olefins with the dithiophosphoric acid;
wherein the dithiophosphoric acid compound of Formula (I) is:

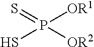

wherein:
R¹ and R² are each individually alkyl, heteroalkyl, cycloalkyl, heterocyclyl, aryl, heteroaryl, or aralkyl; or
R¹ and R² are joined together with the oxygen atoms to which they are attached and any intervening atoms to form a ring.
Para. 46. The method of Para. 45, wherein contacting the polymer comprising one or more olefins with the dithiophosphoric acid does not require a solvent.
Para. 47. The method of Para. 45 or Para. 46, wherein the dithiophosphoric acid is used as the solvent or solubilizer.
Para. 48. The method of any one of Paras. 45-47, wherein contacting the polymer comprising one or more olefins with the dithiophosphoric acid requires heating of at least about 80° C.
Para. 49. The method of Para. 48, wherein contacting the polymer comprising one or more olefins with the dithiophosphoric acid requires heating of about 100° C.
Para 50. The method of any one Paras. 45-49, wherein the dithiophosphoric acid reacts with the polymer comprising one or more olefins in a Markovnikov manner.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### REFERENCES

1) Ozturk, T.; Ertas, E.; Mert, 0. “A Berzelius Reagent, Phosphorous Decasulfide (P4S10), in Organic Syntheses” Chem. Rev. 2010, 110, 3419-3478.
2) a) Norman, G. R.; LeSuer, W. N.; Mastin, T. W. “Chemistry of the Aliphatic Esters of Thiophosphoric Acids. II. O, O, S-Trialkyl Thionophosphates by the Addition of 0,0-Dialkyl Thiolthionophosphoric Acids to Olefins” J. Am. Chem. Soc. 1952, 74, 161-163; b) Norman, G. R.; LeSuer, W. N.; Mastin, T. W. “Chemistry of the Aliphatic Esters of Thiophosphoric Acids. III. Alkoxide Cleavage of O, O, S-Trialkyl Phosphorodithioates” J. Am. Chem. Soc. 1954, 76, 670-676; c) Oswald, A. A.; Griesbaum, K.; Hudson, B. E. “Organic Sulfur Compounds. IX. Addition of Diethyldithiophosphoric Acid to Dienes” J. Org. Chem. 1963, 28, 1262-1268.
3) a) Mebah, J. M. D.; Mieloszynski, J. L.; Paquer, D. “Reactivity of O,O-Diethyldithiophosphoric Acid Towards Different Ethylenic Systems” Phosphorus Sulfur Silicon Relat. Elem. 1992, 73, 49-56; b) Mebah, J. M. D.; Mieloszynski, J. L.; Paquer, D. “Selective Addition of O,O-Diethyldithiophosphoric Acid to Bifunctionalized Compounds” Phosphorus Sulfur Silicon Relat. Elem. 1993, 78, 215-222; c) Robert, D.; Mieloszynski, J. L.; Paquer, D. “Reactivity of O,O-Diethyldithiophosphoric Acid Towards Different Allylic Compounds” Phosphorus Sulfur Silicon Relat. Elem. 1994, 97, 83-87; d) Dodin-Carnot, V.; Curci, M.; Wilhelm, J. C.; Mieloszynski, J. L.; Paquer, D. “Reactivite De L'Acid O,O-Diisopropyldithiophosphorique Sur Des Alcynes Vrais Sulfures” Phosphorus Sulfur Silicon Relat. Elem. 1995, 107, 219-226; e) Dodin-Carnot, V.; Stephan, B.; Curci, M.; Mieloszynski, J. L.; Paquer, D. “Action of Dithiophosphoric Acid Towards Sulfurated Alkynes in Presence of Transition-Metal Catalyst” Phosphorus Sulfur Silicon Relat. Elem. 1996, 108, 1-5; f) Dodin-Carnot, V.; Stephan, B.; Curci, M.; Mieloszynski, J. L.; Paquer, D. “Reactivity of Dithiophosphoric Acid Towards Sulfurated Monosubstituted Alkynes in Presence of Transition-Metal Catalyst” Phosphorus Sulfur Silicon Relat. Elem. 1996, 117, 225-230; g) Jullian, Y.; Georges, J.; Sindt, M.; Schneider, M.; Mieloszynski, J. L.; Paquer, D. “Syntheses D'esters Dithiophosphorique Comportant Les Fonctions —SO2-OH Et —O—SO2-OH” Phosphorus Sulfur Silicon Relat. Elem. 1998, 134, 137-149.
4) a) Nizamov, I. S.; Nizamov, I. D.; Popovich, Y. E.; Cherkasov, R. A. “Reactions of 0,0-Dialkyldithiophosphoric Acids with Hexadec-1-ene. Catalysis with Zinc Chloride” Russ. J. Gen. Chem. 2008, 78, 1290-1291; b) Nizamov, I. S.; Nizamov, I. D.; Popovich, Y. E.; Cherkasov, R. A. “Reactions of O,O-Dialkyldithiophosphoric Acids with Non-Activated a-Olefins” Russ. J. Gen. Chem. 2012, 82, 27-32; c) Kursheva, L. I.; Nizamov, I. S.; Batyeva, E. S.; Nizamov, I. D.; Yambushev, F. D; Cherkasov, R. A. “O,O-Dialkyldithiophosphoric Acids in the Reactions with Non-Activated a-Olefins” Phosphorus Sulfur Silicon Relat. Elem. 2013, 188, 487-489.
5) Shapiro, N. D.; Rayniyar, V.; Hamilton, G. L.; Wu, J.; Toste, F. D. “Asymmetric Additions to Dienes Catalysed by a Dithiophosphoric Acid” Nature 2011, 470, 245-249.
6) a) Lowe, A. B. “Thiol-ene “Click” Reactions and Recent Applications in Polymer and Materials Synthesis: A First Update” Polym. Chem. 2014, 5, 4820-4870; b) Fraser, R. C.; Wilson, C. M.; Badyal, J. P. S. “Plasmachemical Double Click Thiol-ene Reactions for Wet Electrical Barriers” ACS Appl. Mater. Interfaces 2016, 8, 21832-21838; c) Deepak, V. D.; Gungor, E.; Gauthier, M. “Facile Synthesis of poly(isobutylene-co-isoprene) (IIR) Carboxylated Derivatives by Thiol-ene Click Chemistry” Polym. J. 2021, 53, 323-330; d) van Hensbergen, J. A., Burford, R. P. and Lowe, A. B. Post-functionalization of a ROMP polymer backbone via radical thiol-ene coupling chemistry. J. Polym. Sci. A Polym. Chem. 2013, 51: 487-492; e) Wolfberger, A., Rupp, B., Kern, W., Griesser, T. and Slugovc, C. (2011), Ring Opening Metathesis Polymerization Derived Polymers as Photoresists: Making Use of Thiol-ene Chemistry. Macromol. Rapid Commun., 32: 518-522.

What is claimed is:

1. A composition comprising a reaction product of a polymer comprising one or more olefins and a dithiophosphoric acid compound of Formula (I) or Formula (II): 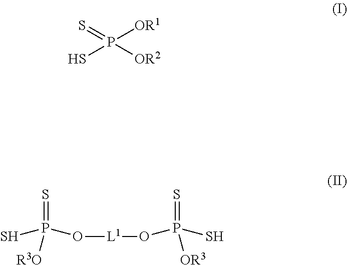
wherein:
R¹ and R² are each individually alkyl, heteroalkyl, cycloalkyl, heterocyclyl, aryl, heteroaryl, or aralkyl; or
R¹ and R² are joined together with the oxygen atoms to which they are attached and any intervening atoms to form a ring,
each R³ is individually alkyl, heteroalkyl, cycloalkyl, heterocyclyl, aryl, heteroaryl, or aralkyl; and
L¹ is alkylene.

2. The composition of claim 1, wherein the compound is of Formula (I).

3. The composition of claim 2, wherein R¹ and R² are each individually alkyl.

4. The composition of claim 2, wherein R¹ and R² are joined together with the oxygen atoms to which they are attached and any intervening atoms to form a ring.

5. The composition of claim 2, wherein the dithiophosphoric acid compound is any one of the following:

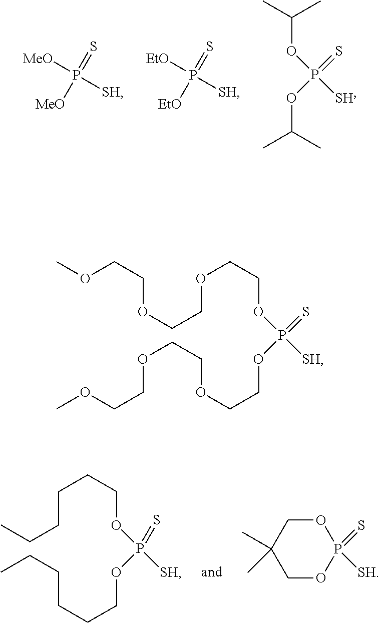

6. The composition of claim 1, wherein the compound is of Formula (II).

7. The composition of claim 6, wherein each R³ are individually alkyl or L¹ is C₄ to C₂₀ alkylene.

8. The composition of claim 6, wherein the dithiophosphoric acid compound is any one of the following:

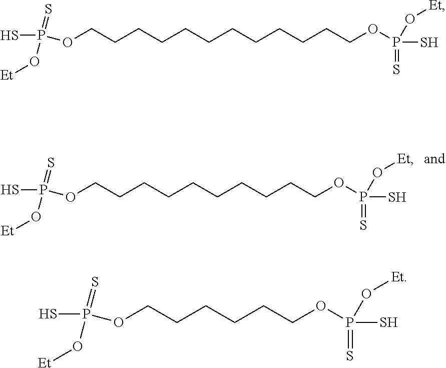 [SMILES: CCOP(=S)(S)OCCCCCCCCCCCCOP(=S)(S)OCC ; CCOP(=S)(S)OCCCCCCCCCCOP(=S)(S)OCC ; CCOP(=S)(S)OCCCCCCOP(=S)(S)OCC]

9. The composition of claim 1, wherein the polymer comprising one or more olefins is a reaction product of a ring-opening metathesis polymerization of a cycloalkene or norbornene.

10. The composition of claim 9, wherein the cycloalkene is a strained olefin or the polymer comprising one or more olefins is polynorbornene.

11. The composition of claim 10, wherein the polynorbornene comprises a dithiophosphoric acid moiety and has the following formula of: 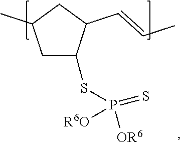
wherein each R⁶ is independently alkyl, heteroalkyl, cycloalkyl, heterocyclyl, aryl, heteroaryl, or aralkyl.

12. The composition of claim 1, wherein the polymer comprising one or more olefins is polybutadiene or polyisoprene, optionally the polyisoprene is cis-1,4-polyisoprene.

13. The composition of claim 1, wherein the reaction product is of the formula: 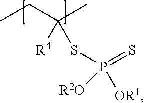
wherein R⁴ is alkyl, heteroalkyl, cycloalkyl, heterocyclyl, aryl, heteroaryl, or aralkyl, or 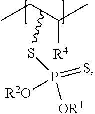
wherein R⁴ is hydrogen.

14. The composition of claim 1, wherein the reaction product is of the formula: 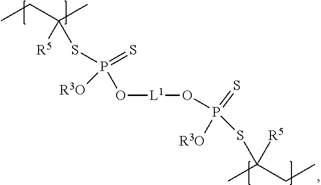
wherein each R⁵ is independently alkyl, heteroalkyl, cycloalkyl, heterocyclyl, aryl, heteroaryl, or aralkyl, or 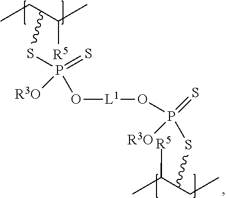
wherein each R⁵ is independently hydrogen.

15. An article of manufacture comprising a reaction product of claim 1.

16. A fire retardant composition comprising a reaction product of claim 1.

17. An optical polymer composition comprising a reaction product of claim 1.

18. A method for making a reaction product of a polymer comprising one or more olefins and a dithiophosphoric acid compound of Formula (I) or Formula (II): 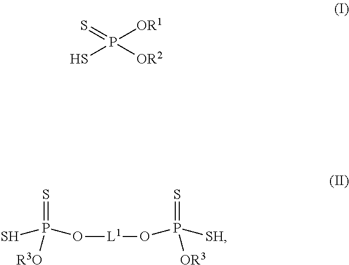
the method comprising:
contacting the polymer comprising one or more olefins with the dithiophosphoric acid;
wherein:
R¹ and R² are each individually alkyl, heteroalkyl, cycloalkyl, heterocyclyl, aryl, heteroaryl, or aralkyl; or
R¹ and R² are joined together with the oxygen atoms to which they are attached and any intervening atoms to form a ring;
each R³ are individually alkyl, heteroalkyl, cycloalkyl, heterocyclyl, aryl, heteroaryl, or aralkyl; and
L¹ is alkylene.

19. The method of claim 18, wherein contacting the polymer comprising one or more olefins with the dithiophosphoric acid does not require a solvent or the dithiophosphoric acid is used as the solvent or solubilizer.

20. The method of claim 18, wherein contacting the polymer comprising one or more olefins with the dithiophosphoric acid requires heating of at least about 80° C.
